(19) United States
(12) Patent Application Publication
(10) Pub. No.: US 2005/0159981 A1
(43) Pub. Date: Jul. 21, 2005

(54) Hospital information system

(75) Inventors: Tsuyoshi Nagaeda, Saitama (JP); Kazuhiro Akiyama, Tokyo (JP); Kiyobumi Watanabe, Tokyo (JP); Hitoshi Suzuki, Tokyo (JP); Yasuyuki Fukuhara, Tokyo (JP); Shinichi Omori, Tokyo (JP); Masafumi Kobayashi, Sagamihara (JP); Kazuyuki Inokihara, Tokyo (JP)

Correspondence Address: SCULLY SCOTT MURPHY & PRESSER, PC, 400 GARDEN CITY PLAZA, SUITE 300, GARDEN CITY, NY, 11530, US

(73) Assignee: OLYMPUS CORPORATION, TOKYO (JP)

(21) Appl. No.: 10/993,114

(22) Filed: Nov. 19, 2004

(30) Foreign Application Priority Data
Dec. 18, 2003 (JP) 2003-420718
Nov. 21, 2003 (JP) 2003-392504
Dec. 1, 2003 (JP) 2003-401378

(51) Int. Cl. G06F 17/60

(52) U.S. Cl. 705/2

(57) ABSTRACT

A hospital information system for managing clinical path information constituted of a plurality of medical service information each indicating a schedule regarding a medical service for a patient, comprising: an obtaining unit for obtaining the clinical path information; a converting unit for converting the clinical path information into medical service notification information for notifying the medical service information to a medical department linked to the medical service in accordance with the medical service information; and a transmitting unit for transmitting the medical service notification information to the medical department.

### CROSS REFERENCE TO RELATED APPLICATIONS

This application is based on and claims the benefit of priority from the prior Japanese Patent Application No. 2003-420718 filed in Japan on Dec. 18, 2003, the entire contents of which are incorporated by this reference.

This application is based on and claims the benefit of priority from the prior Japanese Patent Application No. 2003-392504 filed in Japan on Nov. 21, 2003, the entire contents of which are incorporated by this reference.

This application is based on and claims the benefit of priority from the prior Japanese Patent Application No. 2003-401378 filed in Japan on Dec. 1, 2003, the entire contents of which are incorporated by this reference.

### BACKGROUND OF THE INVENTION

1. Field of the Invention

The present invention relates to a system for efficiently utilizing patient information in a medical site.

Also, the present invention relates to a hospital information system in which an implementation record of a medical service based on a clinical path can be input and output with a mobile terminal, the record of the implemented medical service can be stored, a variance can be recognized, and the clinical path can be modified.

Also, the present invention relates to a technique for providing assistance so that suitable medical service can be conducted on a patient in a medical facility such as a hospital, a clinic or the like.

2. Description of the Related Art

In recent years, in various department systems such as an endoscope examination system, a radiological examination system, a nursing system and the like (Hereinafter, these systems are referred to also as subsystems. A system consisting of such subsystems is called “hospital information system”.), assistances of IT (Information technology) are promoted, and in each of the subsystems, the examination results, patient information, and the like are managed as data.

Conventionally, each order information regarding medical services on a patient have been exchanged among subsystems by means of paper, such that the contents on the paper have been duplicately input to respective subsystems of respective departments by responsible persons.

Also, thanks to the promoted assistances of IT in recent years, the order information about a patient which is input on one terminal can be transmitted to a subsystem of a department which is to implement the medical service specified in the information.

Recently, a clinical path is introduced for a higher efficiency of medical services in a medical field. A clinical path is a standardized schedule of hospitalization and treatment in response to kinds of diseases, specifically, is a schedule made by arranging treatment, examination, care, procedure, instruction and the like along a time axis, for a patient having a particular kind of disease.

In a medical site, a clinical path is printed on a sheet of paper and the orders printed on a sheet are input in respective subsystems so that medical services conducted by plural subsystems are managed as a medical plan.

Also, an invention is disclosed in which medical services are managed by introducing a medical path. (See Japanese Patent Publication No. 2001-118014 and Japanese Patent Publication No. 2003-108661, for example)

Recently, a clinical path is introduced for a higher efficiency of medical services in a medical field. A clinical path is a standardized schedule of hospitalization and treatment in response to kinds of diseases, specifically, is a schedule made by arranging treatment, examination, care, procedure, instruction and the like along a time axis for a patient having a particular kind of disease.

By the way, a gap between a supposed standardized progress of a patient on a clinical path and the actual progress of the patient is called a variance (deviation). By analyzing the variance, the hindrance factors for the standardization of processes of medical care are identified so that the removal of the hindrance factors leads to a more effective medical care. Also, in a clinical path, a result, an effect or a target that a patient will be discharged from a hospital safely is called an outcome.

A system making the most of such a clinical path as above is disclosed in which a nursing and treating plan regarding respective nursing and treating services in response to patients and the kinds of diseases or ailments can be easily prepared, and the suitable implementation of the medical services based on the arranged nursing and treating plan can be recorded and confirmed in a hospital, clinic or the like. (See Japanese Patent Publication No. 2003-108661 for example)

Further, in a medical facility such as a hospital, clinic or the like, it is required that an enough medical service is conducted on a patient. Today, in addition to that, a quality and an efficiency of medical service are strongly required. In order to meet such a requirement, recently, medical facilities are increasing in number which facilities introduce a clinical path (medical schedule data) which is prepared by arranging indispensable medical services which have to be conducted for a patient having a particular ailment by a medical team, the implementation order and timing thereof. (See Japanese Patent Publication No. 2003-108661)

By introducing a clinical path, indispensable medical services such as a treatment, an examination, an observation, medication or the like can be sequentially conducted at suitable times. Therefore, a higher quality of medical service can always be maintained and also cost can be reduced. Further, thanks to the higher quality service maintained as above, the number of days while which a patient stays in a medical facility (days of hospitalization) can be reduced.

### SUMMARY OF THE INVENTION

A hospital information system for managing clinical path information constituted of a plurality of medical service information each indicating a schedule regarding a medical service for a patient according to the present invention comprises:

an obtaining unit for obtaining the clinical path information;

a converting unit for converting the clinical path information into medical service notification information for notifying the medical service information to a medical department linked to the medical service in accordance with the medical service information; and

a transmitting unit for transmitting the medical service notification information to the medical department.

Further, a hospital information system for managing clinical path information constituted of a plurality of medical service information each indicating a schedule regarding a medical service for a patient according to the present invention comprises:

an obtaining unit for obtaining the clinical path information;

a converting unit for converting the clinical path information into medical service notification information for notifying the medical service information to a medical department linked to the medical service in accordance with the medical service information; and

a transmitting unit for transmitting the medical service notification information to the medical department.

Further, a hospital information system for managing clinical path information constituted of a plurality of medical service information each indicating a schedule regarding a medical service for a patient according to the present invention comprises:

an obtaining unit for obtaining the clinical path information;

a determining unit for determining whether or not the schedule of the medical service indicated by the medical service information constituting the clinical path information can be implemented; and

a determination result modification notifying unit for making a notification to prompt a modification of the medical service information constituting the clinical path information, based on the determination result by the determining unit.

Further, a hospital information system for managing clinical path information constituted of a plurality of medical service information each indicating a schedule regarding a medical service for a patient according to the present invention comprises:

an obtaining unit for obtaining the clinical path information;

a storing unit for storing linkage information linking the plurality of the medical service information with one another;

a searching unit for, upon receiving modification order information regarding a prescribed medical service information among the clinical path information obtained by the obtaining unit, searching the linkage information for the medical service information linked to the prescribed medical service information; and

a search result modification notifying unit for making a notification to prompt a modification of the medical service information constituting the clinical path information, based on the search result by the searching unit.

Further, a hospital information system according to the present invention comprises:

a holding unit for holding clinical path standardized information which is progress information regarding a standardized medical service toward the target set for each of medical cases, being constituted of a plurality of medical service information each indicating a schedule regarding the medical service for a patient,

a clinical path information for each of patients obtaining unit for obtaining clinical path information for each of patients which is created based on the clinical path standardized information;

a creating and transmitting unit for creating and transmitting order information ordering that the medical service is to be implemented from the medical service information included in the clinical path information for each of the patients; and

an implementation result information obtaining unit for obtaining the implementation result information indicating the implementation result of the medical service implemented based on the order information.

Further, a nursing and medical assisting device for assisting implementation of a medical service for a patient during treatment according to the present invention comprises:

an implementation data obtaining unit for obtaining implementation data indicating content implemented as a medical service for the patient;

a medical schedule data obtaining unit for obtaining medical schedule data indicating a schedule of the medical service which is to be implemented for the patient;

a progress determining unit for determining whether or not, based on implementation data obtained by the implementation data obtaining unit and medical schedule data obtained by the medical schedule data obtaining unit corresponding to the obtained implementation data, a progress of the patient has deviated from the schedule indicated by the medical schedule data; and

a determination presenting unit for presenting determination result by the progress determining unit.

Further, a nursing and medical assisting method for assisting implementation of a medical service for a patient during treatment according to the present invention comprises:

an implementation data obtaining step in which implementation data indicating content implemented as a medical service for the patient is obtained;

a medical schedule data obtaining step in which medical schedule data indicating a schedule of the medical service which is to be implemented for the patient is obtained; and

a progress determining step in which it is determined whether or not, based on implementation data obtained in the implementation data obtaining step and medical schedule data obtained in the medical schedule data obtaining step corresponding to the obtained implementation data, a progress of the patient has deviated from the schedule indicated by the medical schedule data.

Further, a computer data signal realized on carrier waves for assisting implementation of medical service for a patient during treatment according to the present invention causes a computer to execute;

an implementation data obtaining process of obtaining implementation data indicating content implemented as a medical service for the patient;

a medical schedule data obtaining process of obtaining medical schedule data indicating a schedule of the medical service which is to be implemented for the patient;

a progress determining process of determining whether or not, based on implementation data obtained in the implementation data obtaining process and medical schedule data obtained in the medical schedule data obtaining process corresponding to the obtained implementation data, a progress of the patient has deviated from the schedule indicated by the medical schedule data; and

a determination presenting process of presenting determination result by the progress determining process.

### BRIEF DESCRIPTION OF THE DRAWINGS

FIG. 1 shows an entire configuration of a hospital information system according to a first embodiment;

FIG. 2 shows internal configurations respectively employed by the hospital information system according to the first embodiment;

FIG. 3 is a flowchart showing an input of a plan of a clinical path conducted on the hospital information system terminal 2 according to the first embodiment;

FIG. 4 shows a “Selection of clinical path” window according to the first embodiment;

FIG. 5 shows a “Clinical path” displaying window according to the first embodiment;

FIG. 6 shows a window which prompts a modification of a schedule on the “Clinical path” displaying window according to the first embodiment;

FIG. 7 shows a “Reservation for examination” window according to the first embodiment;

FIG. 8 shows an “Input of order” window according to the first embodiment;

FIG. 9 shows an example of clinical path information according to the first embodiment;

FIG. 10 shows a flowchart along which order is issued for each subsystem based on a clinical path information 65 registered in a clinical path database 3 according to the first embodiment;

FIG. 11 shows a medical service master table according to the first embodiment;

FIG. 12 shows a subsystem master table according to the first embodiment;

FIG. 13 shows a medical service-subsystem linkage master table according to the first embodiment;

FIG. 14 shows a flowchart for a modification of a clinical path according to the first embodiment;

FIG. 15 shows a modification of a “Scheduled date” according to the first embodiment;

FIG. 16 shows displayed state of medical service influenced by a modification of “Scheduled date” 64 in FIG. 15 according to the first embodiment;

FIG. 17 shows a massage window for registering contents of modification of medical service influenced by modification according to the first embodiment;

FIG. 18 shows information regarding linkages of medical services by extracting a part from a clinical path according to the first embodiment;

FIG. 19 shows a clinical path/medical service information table according to the first embodiment;

FIG. 20 shows a clinical path link information table according to the first embodiment;

FIG. 21 is a block diagram showing an entire configuration of a hospital information system according to a second embodiment;

FIG. 22 shows a hardware configuration of a PDA according to the second embodiment;

FIG. 23 shows a hardware configuration of a server 205 and a client PC terminal 250 according to the second embodiment;

FIG. 24 shows a concept based on which an implementation order of patient progress information is created from a classification of outcomes (targets) according to the second embodiment;

FIG. 25 shows an example displaying difference of outcomes between standardized progress information and patient progress information according to the second embodiment;

FIG. 26 shows a variance occurrence classification list according to the second embodiment;

FIG. 27 shows a menu for selection of the variance occurrence classification list on the PDA according to the second embodiment;

FIG. 28 shows a simplified flowchart for processes from selection of a clinical path and issue of order to review of the order according to the second embodiment;

FIG. 29 is a flowchart for showing, in detail, a series of processes from selection of a clinical path and issue of order to review of the order according to the second embodiment;

FIG. 30 shows a configuration of a hospital information system comprising a nursing and medical assisting device according to a third embodiment;

FIG. 31 shows a function configuration of an in-hospital information managing system comprising the nursing and medical assisting device according to the third embodiment;

FIG. 32 explains a data configuration of a variance table according to the third embodiment;

FIG. 33 is a flowchart of a variance determining process according to the third embodiment;

FIG. 34 is a flowchart for showing processes respectively executed by a terminal device and an in-hospital information managing system to realize an input of factor according to the third embodiment;

FIG. 35 explains a warning message outputting window according to the third embodiment;

FIG. 36 explains a counter plan outputting window according to the third embodiment;

FIG. 37 explains a factor inputting window according to the third embodiment; and

FIG. 38 explains a variance cause comment registration window.

### DESCRIPTION OF THE PREFERRED EMBODIMENTS

### FIRST EMBODIMENT

A hospital information system for managing clinical path information constituted of a plurality of medical service information each indicating a schedule regarding a medical service for a patient according to a first embodiment of the present invention comprises:

an obtaining unit for obtaining the clinical path information;

a converting unit for converting the clinical path information into medical service notification information for notifying the medical service information to a medical department linked to the medical service in accordance with the medical service information; and

a transmitting unit for transmitting the medical service notification information to the medical department.

Thanks to the above configuration, order information can be transmitted to a plurality of subsystems of linked departments by one input operation of a clinical path so that the clinical path can be unitarily managed.

Further, in the hospital information system according to the first embodiment of the present invention:

the converting unit extracts the medical service information from the clinical path information obtained by the obtaining unit in order to add information regarding the medical department to the extracted medical service information.

Thanks to the above configuration, each medical service information included in a clinical path can be suitably transmitted to subsystems of departments linked to the medical service.

Further, a hospital information system for managing clinical path information constituted of a plurality of medical service information each indicating a schedule regarding a medical service for a patient according to the first embodiment of the present invention comprises:

an obtaining unit for obtaining the clinical path information;

a determining unit for determining whether or not the schedule of the medical service indicated by the medical service information constituting the clinical path information can be implemented; and

a determination result modification notifying unit for making a notification to prompt a modification of the medical service information constituting the clinical path information, based on the determination result by the determining unit.

Thanks to the above configuration, in the stage of the setting of the medical service, the reservation situation of the medical service can be confirmed in advance in order to make a reservation of the medical service when there are empty reservation slots.

Further, in the hospital information system according to the first embodiment of the present invention:

the determining unit compares a scheduled time and date of the medical service included in the medical service information constituting the clinical path information obtained by the obtaining unit, with a possible time and date for implementation or an impossible time and date for implementation of the medical service of the medical department linked to the medical service.

Thanks to the above configuration, the situation of reservation slots can be confirmed in a unit of time and date.

Further, a hospital information system for managing clinical path information constituted of a plurality of medical service information each indicating a schedule regarding a medical service for a patient according to the first embodiment of the present invention comprises:

an obtaining unit for obtaining the clinical path information;

a storing unit for storing linkage information linking the plurality of the medical service information with one another;

a searching unit for, upon receiving modification order information regarding a prescribed medical service information among the clinical path information obtained by the obtaining unit, searching the linkage information for the medical service information linked to the prescribed medical service information; and

a search result modification notifying unit for making a notification to prompt a modification of the medical service information constituting the clinical path information, based on the search result by the searching unit.

Thanks to the above configuration, order information can be transmitted to a plurality of subsystems of linked departments by one input operation of a clinical path upon a modification of the clinical path.

Further, in the hospital information system according to the first embodiment of the present invention:

the linkage information includes information indicating interval hours of the scheduled time and date indicated by the linked medical service information; and

the search result modification notifying unit makes the notification including a modification example of the medical service information created based on the interval hours corresponding to the medical service information searched for by the searching unit.

Thanks to the above configuration, it can be presented by how many hours (or days) the medical service has to be shifted regarding a modification of the linked medical service accompanying a modification of one medical service.

Further, the hospital information system according to the first embodiment of the present invention further comprises:

a converting unit for obtaining the clinical path information in accordance with the medical service information modified after the notification by the search result modification notifying unit in order to convert the clinical path information into medical service notification information for notifying the medical service information to a medical department linked to the medical service in accordance with the medical service information; and

a transmitting unit for transmitting the medical service notification information to the medical department.

Thanks to the above configuration, when a medical service is influenced by a modification of one medical service, the influenced medical service can be searched for and the fact of the influence can be notified.

Further, in the hospital information system according to the first embodiment of the present invention:

the converting unit extracts the medical service information from the clinical path information obtained by the obtaining unit in order to add information regarding the medical department to the extracted medical service information.

Thanks to the above configuration, order information can be transmitted to a plurality of subsystems of linked departments by one input operation of a clinical path upon a modification of the clinical path.

Hereinafter, the first embodiment will be explained.

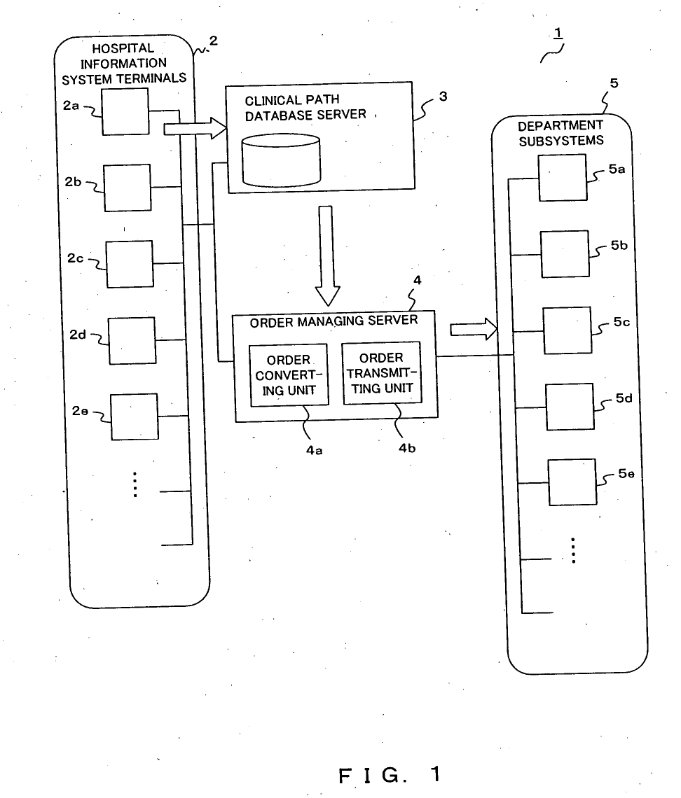

FIG. 1 shows an entire configuration of a hospital information system. The hospital information system 1 comprises hospital information terminals 2 (2a, 2b, 2c, 2d, 2e, . . . ), a clinical path database server 3, an order managing server 4, department subsystems 5 (5a, 5b, 5c, 5d, 5e, . . . ) and a LAN for connecting the above components with one another. The clinical path database server 3 and the order managing server 4 can be configured both in a physically coupled manner and in a physically separated manner.

The hospital information system terminals 2 (2a, 2b, 2c, 2d, 2e, . . . ) can prepare/display a patient's clinical path, input the order, display the contents and results of implementation, and input/display the patient information. Also, the information input in each of the hospital information system terminals 2 is transmitted to the clinical database server 3.

In the clinical path database server 3, a plan of a clinical path and the content and result of the implementation for each of the patients transmitted from each of the hospital information system terminals 2 is stored. Also, in the clinical path database server 3, model data in response to respective diseases/ailments are registered in order to be utilized as standard data upon preparing a plan of hospitalization/treatment for each of the patients.

The model data for clinical path is configured as a schedule table including medical services such as a treatment, an examination, medication and the like in a combined state thereof. As the model data, medical services conducted between both ends of schedule, e.g. between the hospitalization and the discharge are input. Because there are linkages among respective medical services and there exist linkages there among that a particular treatment requires a particular nursing service in response, data indicating such linkage is also registered. Also, the stored plan of clinical path for each patient and content/result of the implementation are transmitted to the order managing server 4.

The order managing server 4 comprises an order converting unit 4a and an order transmitting unit 4b. The order converting unit 4a extracts each medical service information from a received clinical path for each patient in order to convert the medical service information into the order information. The order transmitting unit 4b transmits the order information to a department subsystem responsible for the order.

The department subsystems 5 include, for example, a nursing system, an operating system, a feeding system, a drug system, systems of respective examination departments and the like. Each of the subsystems 5 (5a, 5b, 5c, 5d, 5e, . . . ) comprises a PC terminal, a server, a mobile terminal and the like, which are connected with one another via a LAN. In each department subsystem, a medical service is implemented based on the order information transmitted from the order managing server 4 and the implementation record of the implemented medical service (content and result and the like of implementation) is stored. Thereafter, a part of the implementation record (the necessary information) is transmitted to the clinical path database server 3 or the order managing server 4.

Thereafter, the clinical path database server 3 receives the implementation record transmitted from the department subsystems 5 and stores the implementation record therein.

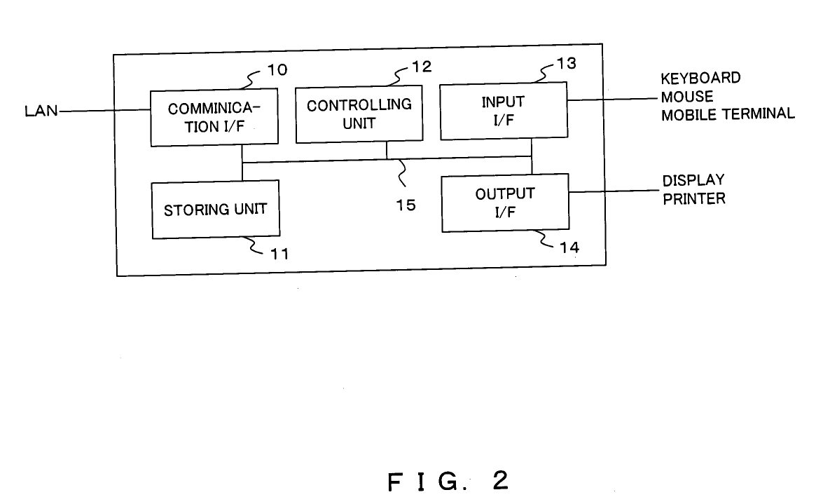

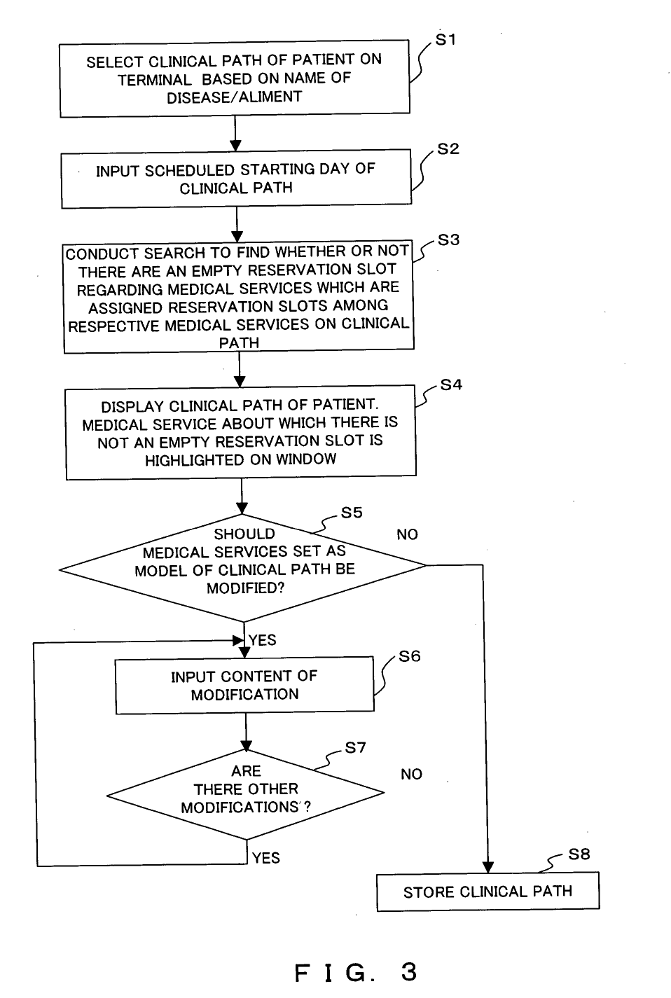

FIG. 2 shows an internal conceptual configuration respectively employed by the hospital information system terminal 2, the clinical path database server 3, the order managing server 4 and the department subsystems 5. FIG. 2 shows a controlling unit (CPU) 12 for processing and calculating by a program, a storing unit 11 for storing necessary data therein, an input interface 13 (hereinafter, the interface is referred to as I/F) for connecting such inputting devices as a mouse, a keyboard, a mobile terminal and the like with one another so that an order, data or the like can be input via the above inputting devices, an output I/F 14 for connecting such outputting devices as a printer, a displaying unit and the like with one another so that data can be output to the above outputting devices, a communication I/F 10 for a connection with a LAN or the like, and a bus 15 for connecting all of the above components with one another.

FIG. 3 is a flowchart showing an input of a plan of a clinical path conducted on the hospital information system terminal 2. The patient's clinical path is input on the hospital information system terminal 2 by an operator. The operator activates a program according to the present embodiment as shown in FIG. 3 installed in the hospital information system terminal 2 by the mouse or the like.

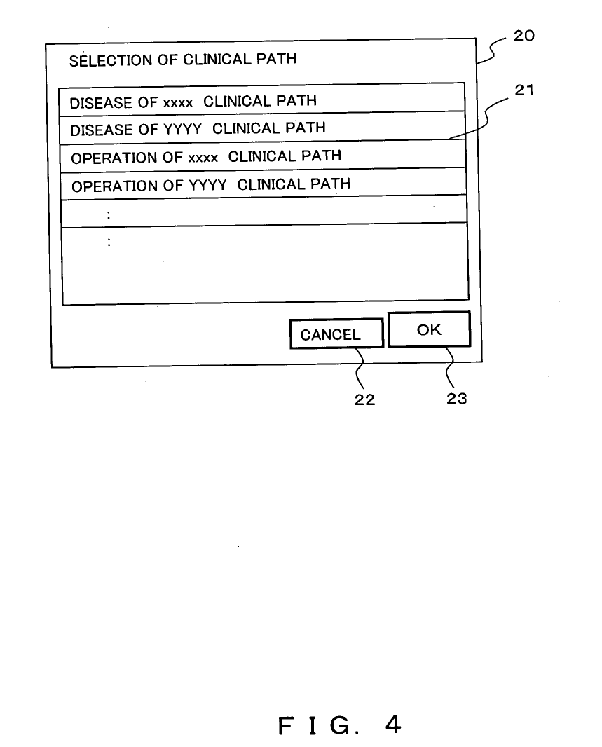

Upon receiving an activating order in the above manner, the controlling unit 12 reads the above described program stored in the storing unit 11 in order to activate the program as shown in a flowchart of FIG. 3. When that program is activated, a menu window of a clinical path setting system is displayed on the displaying unit. The menu window includes a plurality of buttons for opening respective processing window in response to processes of respective transactions. When a “Selection of a clinical path” button is selected out of the above buttons, a list for patient selection is displayed, thereafter, when a prescribed patient is selected on the list, a window of FIG. 4 is opened. Hereinafter, windows as shown in respective figures will be explained with reference to the flowchart of FIG. 3.

FIG. 4 shows a “Selection of clinical path” window 20. Now, a case is explained that a name of disease/aliment of a patient is identified and also the clinical path in response to that name of disease/aliment is defined in advance. In FIG. 4, the “Selection of clinical path” window 20 comprises a “Selection of clinical path” list 21, a “Cancel” button 22 for closing the “Selection of clinical path” window 20 and going back to a previous window, and an “OK” button 23 for deciding on the clinical path selected on the “Selection of clinical path” list 21.

On the “Selection of clinical path” list 21, clinical paths in response to prescribed names of diseases/ailments or operations such as “Disease of xxxx Clinical path”, “Disease of YYYY Clinical path”, “Operation of xxxx Clinical path”, “Operation of YYYY Clinical path” and the like are displayed in order to be selected. The respective names of clinical paths displayed in the “Selection of clinical path” list 21 are the information obtained from the clinical path database server 3 upon transition to the “Selection of clinical path” window 20.

Firstly, an operator selects a clinical path in response to a patient at the hospital information system terminal 2 (step S1, hereinafter the step is expressed as “S”). Specifically, a clinical path which responds to the disease/ailment of a patient is selected on a list of clinical paths in response to respective diseases/ailments registered in the clinical path database server 3 and thereafter, the “OK” button 23 is pressed.

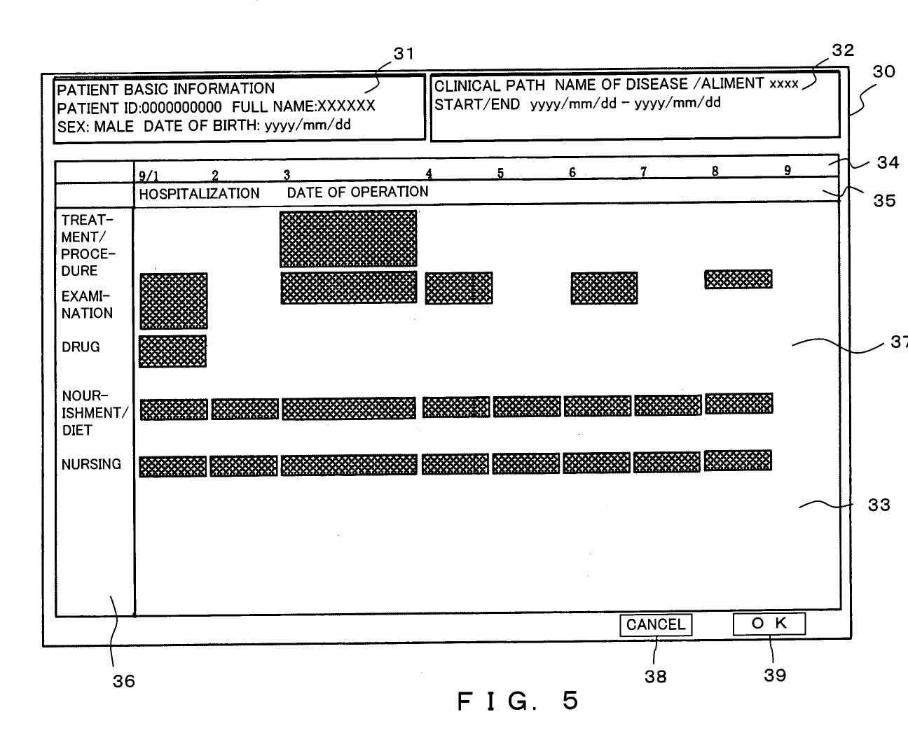

After pressing the “OK” button 23, a window (not shown) is opened on which a scheduled starting date e.g. date of hospitalization is selected or is input as a setting of clinical path (S2). Thereafter, by pressing an “OK” button on the above window, a window shown as in FIG. 5 is opened. On that window, when the period of hospitalization is set as ten days and the date of hospitalization is set as September 1 on the selected clinical path for example, a schedule of medical services from September 1 to September 10 is displayed on the window.

FIG. 5 shows a clinical path displaying window 30. The clinical path displaying window 30 displays patient basic information, a name of selected clinical path, a plan table between the starting date and the ending date. Specifically, the clinical path displaying window 30 comprises a “Patient basic information” displaying column 31, a “Clinical path basic information” displaying column 32, a “Clinical path detail information” column 33, a “Cancel” button 38 for closing the window 30 and going back to a previous window and an “OK” button 39 for registering the information set on the window 30 in the clinical database server 3.

On the “Patient basic information” displaying column 31, patient ID, full name, sex, date of birth of a patient about whom the clinical path is set are displayed. Also, in the “Clinical path basic information” displaying column 32, a name of disease/ailment selected on the “Selection of clinical path” list 21 of FIG. 4 and the starting date and the ending date over which the clinical path is applied are displayed.

The “Clinical path detail information” column 33 comprises a horizontal axis 34 for specifying dates, event information 35 for indicating events corresponding to the above dates, “Medical service” items 36 such as a treatment, a procedure, an examination, drug, nourishment, diet, nursing, and the like, and a bar displaying area 37 for displaying bars (hatched portions in FIG. 5) for indicating the number of days in correspondence to each of “Medical service” items 36. As described above, on the bar displaying area 37, each number of days corresponding to each medical service conducted between September 1 and September 10 is displayed as a bar. Further, hereinafter, each of the components of clinical path such as a treatment/procedure, an examination, drug, nourishment, diet, nursing and the like are referred to as a medical service.

As for the items displayed on the above “Clinical path” displaying window 30, the information corresponding to each item is obtained from the clinical path database server 3 upon opening the “Clinical path” displaying window 30. Upon this operation, the clinical path database 3 inquires the order managing server 4 so that when some of the medical services in the clinical path to be displayed are assigned reservation slots, a search is conducted to find whether or not there are empty reservation slots regarding such medical services (S3). This process will be explained later.

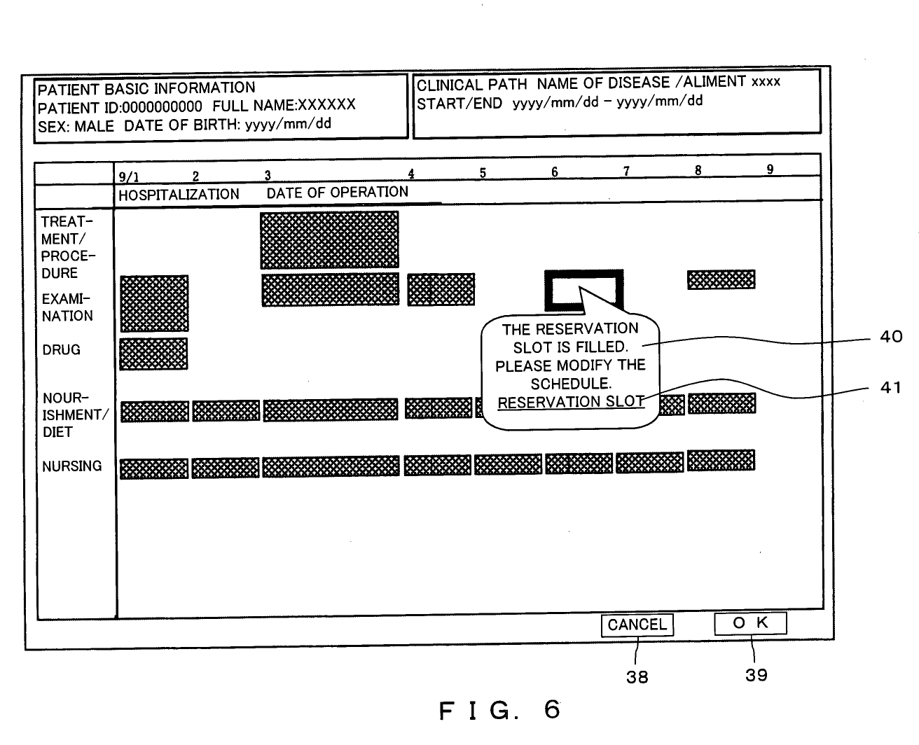

FIG. 6 shows a message which prompts a modification of a schedule on the “Clinical path” displaying window 30. There are cases that a reservation slot for a scheduled time and date which have been automatically set by default is already filled at a time when the “Clinical path” displaying window 30 is opened. Also, there are cases that an operator wants to modify the scheduled time and date being automatically set by default in the clinical path regarding each medical service. In such two cases, the scheduled time and date of the medical service can be manually input. Upon this input, it has to be confirmed whether or not there are empty reservation slots regarding the medical services to which reservation slots are assigned. The reservation slot is used for the management of medical services because there are limitations on some of medical services about the number of times and the time period of implementation on a day due to the limitations of the number of examination devices, examination rooms or the like.

When the “Clinical path” displaying window 30 is opened (See FIG. 5), it is determined whether or not the reservation is possible in S3 in case that the clinical path includes a medical service which is assigned a reservation slot. Now, operations in S3 are explained in detail. The search about whether or not a particular reservation slot is empty is conducted in a manner that when the “Clinical path” displaying window 30 is opened the information necessary for opening the “Clinical path” displaying window 30 is obtained from the clinical database server 3.

Upon the above operation, the clinical database server 3 obtains reservation information of each subsystem managed in the order managing server 4 in order to determine whether or not a reservation is possible by comparing the time and date of the medical service included in the clinical path to be displayed on the “Clinical path” displaying window 30 with the reservation information of each subsystem (e.g. reservation time and date information). Also, the reservation information may be directly obtained from a server of each subsystem.

When it is determined, on the clinical database server 3, that any one of the medical services included in the clinical path to be displayed on the “Clinical path” displaying window 30 does not have an empty reservation slot for the time and date set by default, the massage indicating the above determination result is transmitted to each hospital information system terminal 2. And on the hospital information system terminal 2, it is displayed that the scheduled time and date for the medical service has to be modified (FIG. 6). For example, if there is not an empty reservation slot for the examination to be conducted on the morning of the sixth day of the hospitalization when the examination schedule for the above time and date is set on a clinical path, it is displayed that the modification of the time and date is required by changing a color of the words or by highlighting the words (S4).

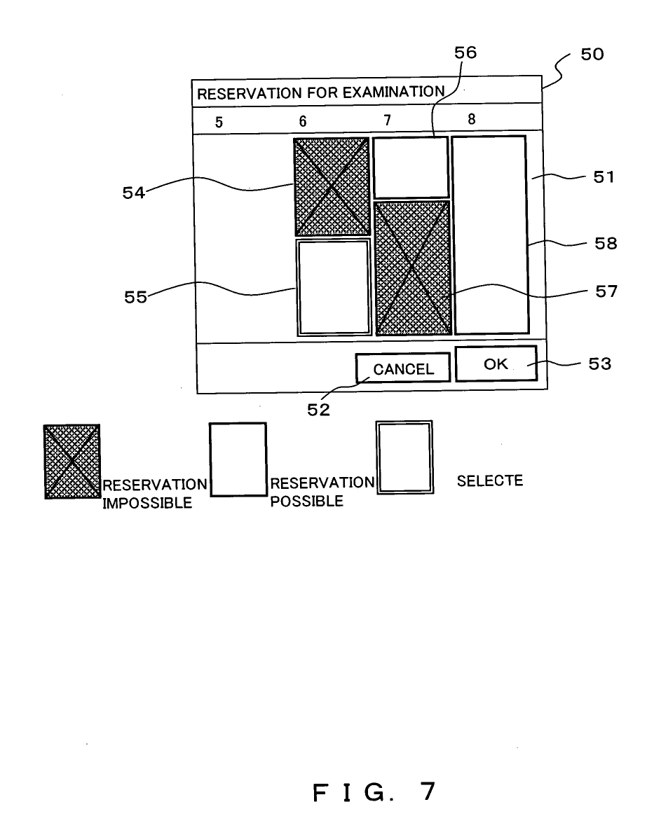

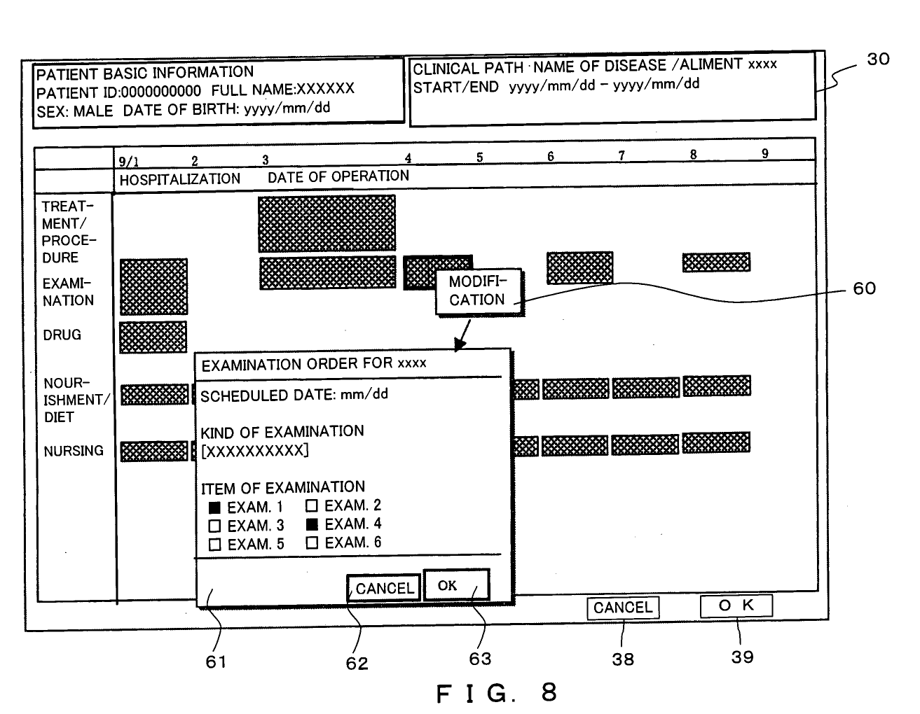

In the present invention, a message 40 saying “The reservation slot is filled. Please modify the schedule” is displayed. Then, by pressing a “Reservation slot” button 41 accompanying the massage 40, a window of FIG. 7 is opened.

FIG. 7 shows a “Reservation for examination” window 50. In FIG. 7, the “Reservation for examination” window 50 comprises a reservation slot setting area 51 with a horizontal axis for date and a vertical axis for time, “Cancel” button 52 for canceling a process on this window and an “OK” button 53 for registering the process on this window. On the “Reservation for examination” window 50, a schedule of examination can be modified.

On the reservation slot setting area 51, status of “Reservation impossible” (hatched portion) and “Reservation possible” (portion framed with thick lines) are indicated. In the present embodiment, there is a “Reservation impossible” sign 54 because the reservation slot for the morning of the sixth day is already filled as described above. Also, as there is a “Reservation impossible” sign 57 about the afternoon of the seventh day, the reservation is impossible. Therefore, one of “Reservation possible” signs 55, 56 and 58 has to be selected. In the present embodiment, a reservation slot for the afternoon of the sixth day is selected. (The selected reservation slot is expressed by a double frame.)

After selecting the reservation slot as above, by pressing an “OK” button 53, the “Reservation for examination” window 50 is closed and the “Clinical path” displaying window 30 is opened. On the “Clinical path detail information” column 33 of the window 30, the updated scheduled date of the modified medical service is displayed.

Next, when detailed order information has to be individually input in addition to the medical services set as a model of the clinical path or when the content of the order should be modified (i.e. “Yes” on S5), an input of order window of FIG. 8 is opened so that the detailed information or the modified information is input (S6). If a modification is not needed on a process of S5, “No” is selected so that the process of S8 is conducted which process will be explained later.

FIG. 8 shows an “Input of order” window 61. On the window, for example, when a content of examination as a medical service “Examination” to be conducted on the fourth day is desired to be modified, by clicking the right mouse button on a bar of examination for the fourth day on the “Clinical path detail information” column 33, a menu 60 is displayed and by selecting “Modification” on the menu, the “Input of order” window 61 is opened. The “Input of order” window 61 comprises “Scheduled date”, “Kind of examination”, “Item of examination (Exam. 1, Exam. 2, Exam. 3, Exam. 4, Exam. 5, Exam. 6) ”, a “Cancel” button 62 for canceling a process on the “Input of order” window 61, and an “OK” button 63 for registering the process on the “Input of order” window 61.

“Scheduled date”, “Kind of examination” and “Item of examination” can be respectively input and modified. However only the modification of item of examination is explained here. For example, it is desired that the Exam. 1 and the Exam. 4 are implemented by modifying the setting by default when Exam. 3 is set on the clinical path by default, by checking checkboxes of Exam. 1 and Exam. 4 and pressing the “OK” button 63 after canceling the check on the checkbox of Exam. 3, the “Input of order” window 61 is closed. Upon this operation, the information of the modified clinical path is updated on the “Clinical path” displaying window 30.

The examples of reasons for modifying the contents of examination by using the “Input of order” window 61 include factors peculiar to a patient, a condition, allergy, infection and the like. Also, when the schedule has to be changed, the “Scheduled date” of the implementation of medical service is modified on the schedule table, which will be described later.

Further, some medical services can be added to the clinical path. For example, by moving a pointer of a mouse on the “Medical service” item 36 and clicking a right mouse button, a menu is displayed. When “Addition of medical service” is selected on the menu, a list of medical service information is displayed so that the medical services are selected therefrom arbitrarily. Upon this operation, the selected medical service is added on the “Clinical path detail information” column.

Thereafter, the operator determines whether or not other modification is needed and if other modification is needed(i.e. “Yes” on S7), the process of S6 is repeated. Also if no other modification is needed on S7, “No” is selected so that a process of S8, which will be explained later, is conducted.

When the input and setting of the medical services which have to be conducted between the scheduled starting date and the ending date of the clinical path after the above processes are completed, the clinical path set on the “Clinical path” displaying window 30 is registered on the clinical path database 3 (S8). Specifically, when the “OK” button 39 is pressed, the information modified on S4 or S6, for example, is transmitted to the clinical database server 3 so that the clinical path information is registered on the clinical path database server 3.

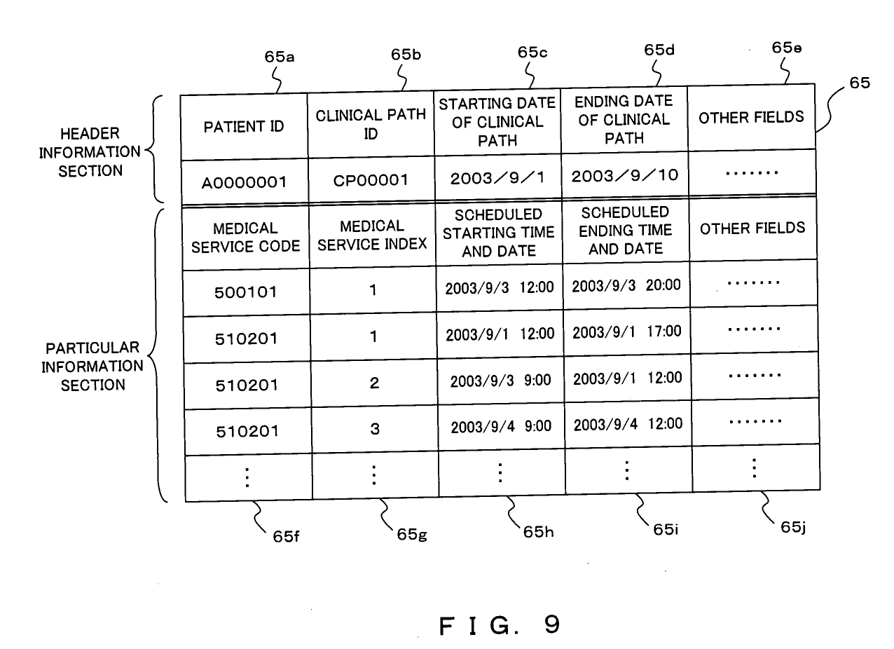

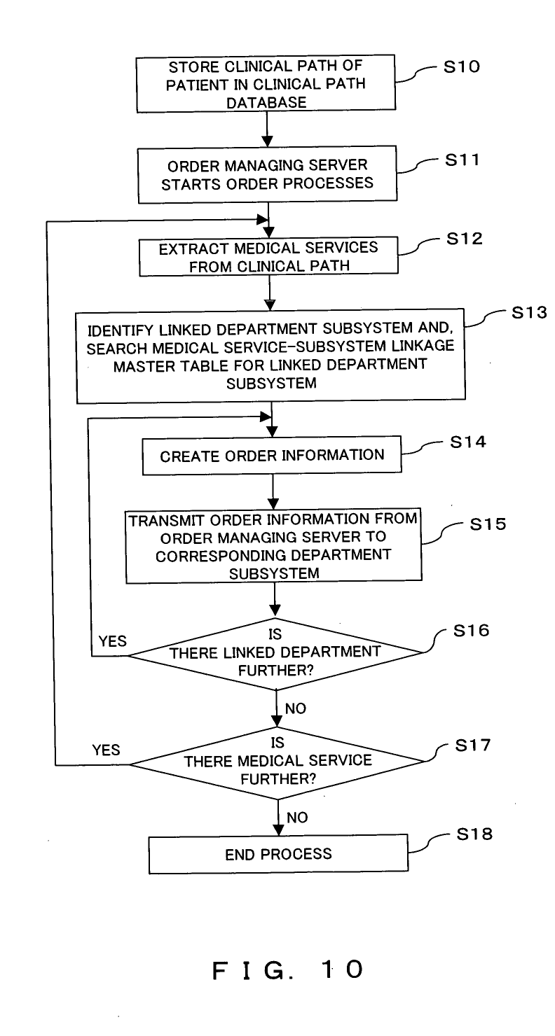

FIG. 9 shows an example of the clinical path information 65 transmitted from each hospital information system terminal 2 to the clinical database server 3. In FIG. 9, the clinical path information 65 includes a header information section and a particular information section. The header information section mainly includes information used for the “Patient basic information” displaying column 31 and information used for the “Clinical path basic information” displaying column 32 on the clinical path displaying window. For example, the header information section comprises “Patient ID” 65a, “Clinical path code” 65b, “Starting date of clinical path” 65c, “Ending date of clinical path” 65d, a group of other fields 65e and the like. It is noted that the “Clinical path code” means a code set in each clinical path.

The particular information section mainly includes the information of the “Clinical path detail information” column 33 such as “Medical service code” 65f, “Medical service index” 65g, “Scheduled starting time and date” 65h, “Scheduled ending time and date” 65i, and a group of other fields 65j and the like, for example. Records as many in the number as the bars displayed on the “Clinical path detail information” column 33 are stored.

The “Medical service code” is the code set for each medical service. The medical service index is a code for discriminating the duplicated medical service codes. For example, the “Treatment/Process” as the medical service of the “Clinical path detail information” column 33 of FIG. 5 corresponds to a record with a medical code 500101 of FIG. 9. Because there is only one “Treatment/Process” as the medical service on September 3, the index of 1 is stored as the “Medical service index” on the record.

Further, the “Examination” as the medical service of the “Clinical path detail information” column 33 of FIG. 5 corresponds to a record with a medical code 510201 of FIG. 9. Because there are five “Treatment/Process” as the medical services on September 3, five corresponding records exist so that the indexes of 1 to 5 are sequentially stored as the “Medical service index”.

Also, in the example above, the reservation slot is managed by the order managing server, however, each reservation slot of each department can be separately managed by each department subsystem.

Next a case that the clinical path information 65 registered in the clinical path database 3 is issued for each subsystem is explained.

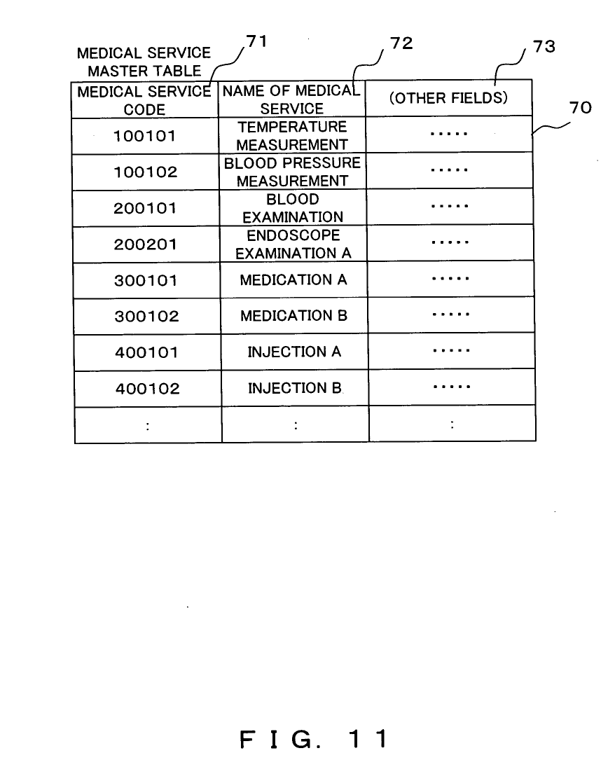

FIG. 10 shows a flowchart along which the order is issued for each subsystem based on the clinical path information 65 registered in the clinical path database 3. The clinical path information 65 is stored in the clinical path database server 3 as above (S10). This is a process of S8 described above. Thereafter, the clinical path information stored in the clinical path database server 3 is transmitted to the order managing server 4.

Next, the order managing server 4 starts the order processes as below (S11). The order managing server 4 extracts individual medical services from the received clinical path information 65 (S12) in order to convert the medical services into the order information to be transmitted to each of the department subsystems responsible for each of the medical services (S13) Information for determining to which of the department subsystems the orders are transmitted is managed by the order managing subsystem for each kind of order.

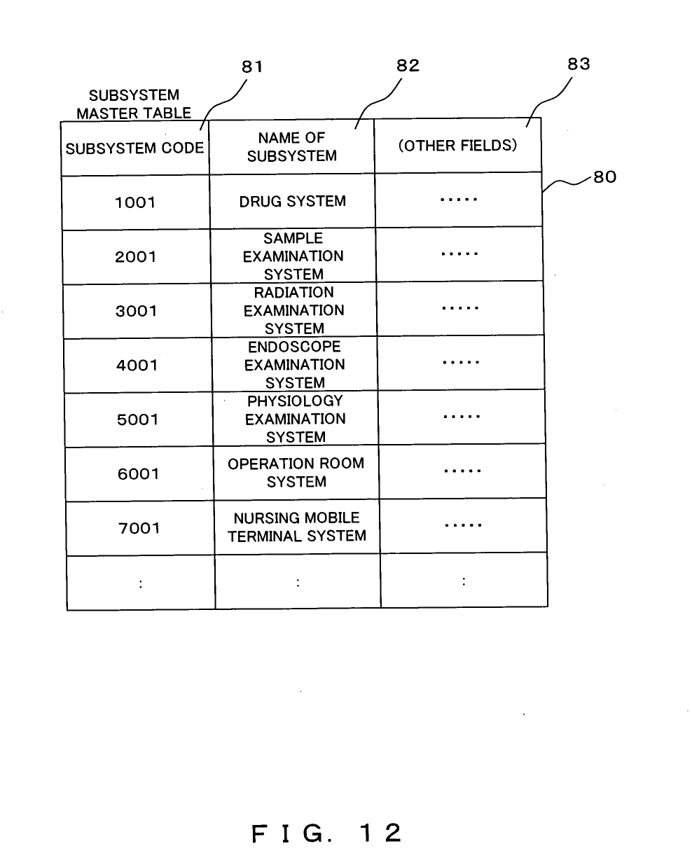

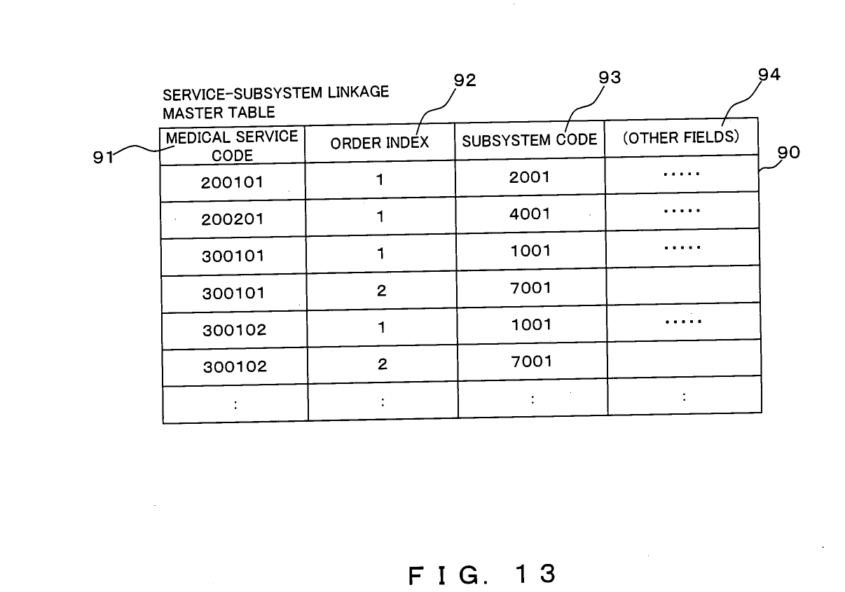

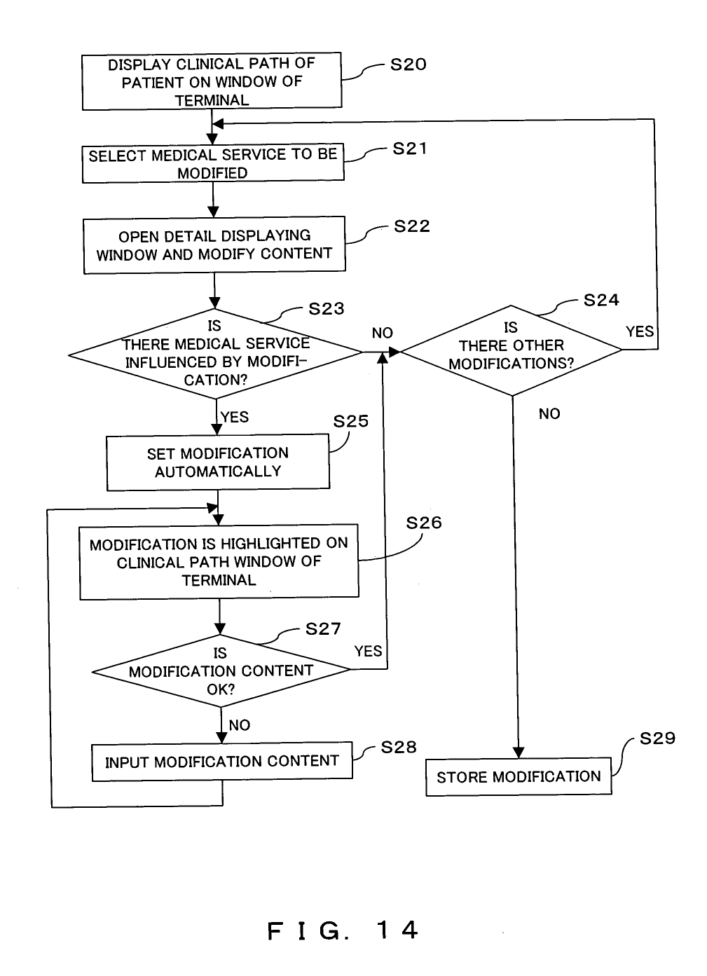

The operations of S13 are explained in more detail based on the master tables of FIGS. 11 to 13. On the database of the clinical path database server 3, there are a medical service master table 70 (FIG. 11), a subsystem master table 80 (FIG. 12) and a medical service-subsystem linkage master table 90 (FIG. 13).

The medical service master table 70 of FIG. 11 is a table for managing medical services which can be set as components of a clinical path for a temperature measurement, a blood pressure measurement or the like. One record comprises a “Medical service code” 71, a “Name of medical service” 72 and a group of fields 73 for storing other necessary information.

The subsystem master table 80 of FIG. 12 is a table for managing the information regarding each of subsystems used for each of departments such as a drug system, endoscope examination system and the like. One record comprises a “Subsystem code” 81, a “Name of subsystem” 82 and a group of fields 83 for storing other necessary information.

The medical service-subsystem linkage master table 90 of FIG. 13 is a table for managing the linkage information for determining which of the orders of medical services are to be transmitted to which of the department subsystems in case that the order of a medical service is issued for a subsystem which has a linkage with the medical service based on the medical service. One record comprises a “Medical service code” 91, an “Order Index” 92, a “Subsystem code” 93 and a group of fields 94 for storing other necessary information. Further, a plurality of subsystems can be linked with one kind of medical service. This configuration is employed taking a possibility that an order of one medical service is transmitted to a plurality of subsystems.

The “Order index” 92 is an item used when a plurality of subsystems are linked with one medical service code. When only one subsystem code is linked with one medical service code, “1” is stored as the “Order Index” 92.

When a plurality of subsystem codes are linked with one medical service code, each order index code is stored for each subsystem code in a manner that the order index is incremented by 1 for each subsystem. Specifically, as shown in FIG. 13, because “Subsystem code 1001” and “Subsystem code 7001” are linked with “Medical service code 300101”, “1” is stored as the “Order Index” 92 for the “Subsystem code 1001” whereas “2” is stored as the “Order Index” 92 for the “Subsystem code 7001”.

Which order is to be transmitted to which subsystem about each medical service extracted from the clinical path order 65 is determined based on the subsystem code corresponding to the code of the extracted medical service by referring to the a medical service-subsystem linkage master table (FIG. 13).

Upon the above operation, there are cases that a plurality of the department subsystems to be transmitted exist. When more than one subsystem are linked, the information necessary for the transmission of the order to the subsystems are obtained by referring to the subsystem master table (FIG. 12) and prepare order text in order to transmit the order text to the subsystems (S14). Examples of the information necessary for the transmission of the order include an IP address or a port number of a server of the department subsystem or the like if a socket communication is employed as communication means for example. And by adding such information, the order text is prepared.

Now, the flowchart of FIG. 10 is again explained. The order managing server 4 transmits an order to one or a plurality of department subsystems (S15). Examples of the cases that an order has to be transmitted to a plurality of department systems for one medical service include a case of an injection order. The injection order requires following operations and the orders are transmitted to the respective department subsystems needed for implementing the following operations (for example, the drug system, the nursing portable terminal system and the like).

1) Instruction in the ward

2) Supply of drug in the drug department

3) Mixing of the drugs in the ward

4) Starting of injection to a patient in the ward

5) Ending of injection to a patient in the ward

As described above, if there is a further department linked with the medical service (“Yes” on S16), the processes of S14 and S15 are repeated. When there is no further department linked (“No” on S16), it is determined whether or not there is further medical service on the clinical path information 65 (S17).

If there is a further medical service in the clinical path information 65 (“Yes” on S17), the processes of S12 to S17 are conducted until the processes of S12 to S17 of all of the medical services included in the clinical path information 65 are completed. When the processes of S12 to S17 of all of the medical services are completed (“No” on S17), the order processes are ended (S18).

In the above explanation, main stream of inputting plan of clinical path, registration in the server and the issue of the order to subsystem is described. Next, a case that a scheduled date on which the medical service set on the clinical path is modified is explained in detail, although some of has already explained above.

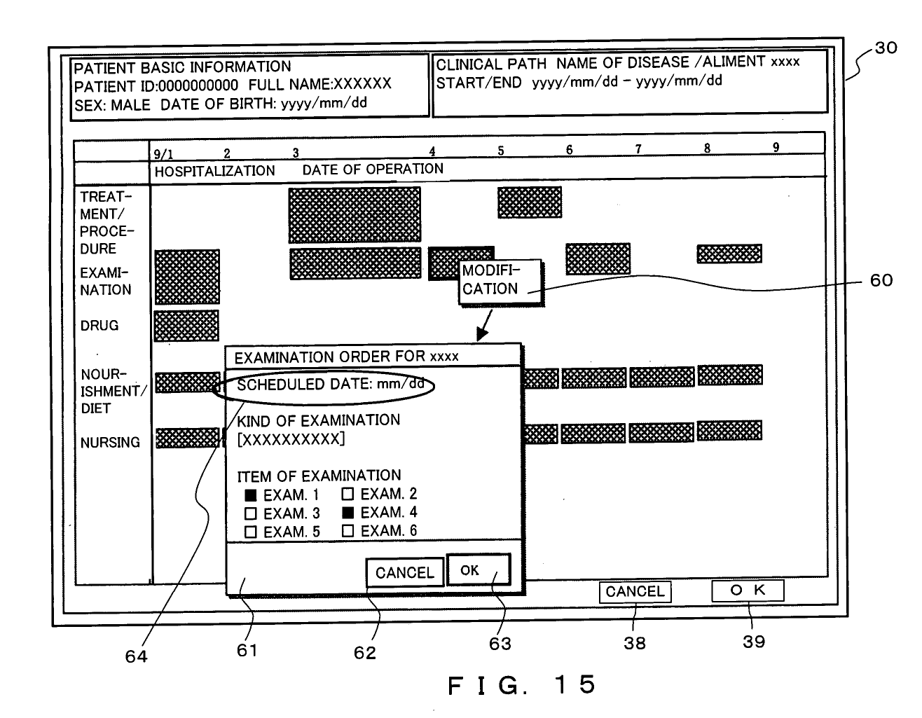

FIG. 14 shows a flowchart for a modification of clinical path. A clinical path can be modified in accordance with a change of situation such as a progress after a medical service or the like. In such a case, the clinical path which is already set on the hospital information system terminal 2 can be modified. Further, in accordance with this modification of the clinical path, modification information of order content can be transmitted to each department subsystem. Now, the above modification is explained below in detail referring to FIG. 14.

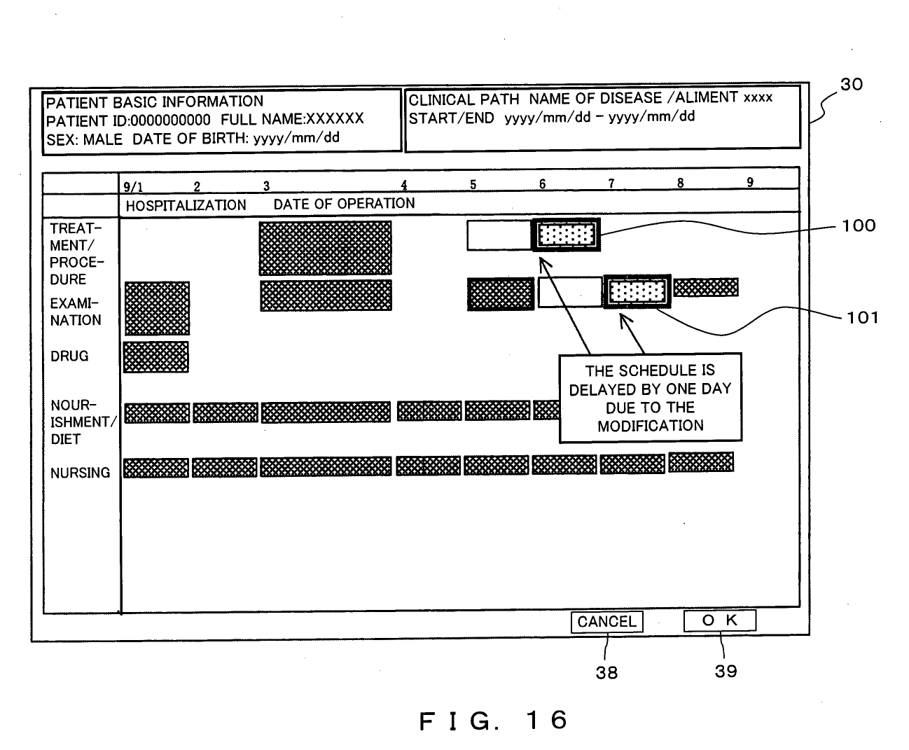

First, the above described clinical path displaying window 30 is opened (S20). Next, the medical service which is needed to be modified is selected on the window of the clinical path as in FIG. 15 (S21) which operation is the same with that explained in FIG. 8. Then, the details of the selected medical service are displayed so that the modification is input. For example, in order to delay the “Examination” as medical service by one day, the “Scheduled date” 64 is modified from “September 4” to “September 5” (S22).

Next, it is determined whether or not there is any plan of medical services influenced by the modification of S22 among the medical services to be conducted after the original scheduled date (i.e. the scheduled date before the modification) (S23). Among such plans of medical services as to be conducted after the original scheduled date, some are influenced and others are not and which plan of medical services is influenced can be indicated because the linkages among the medical services are registered in the clinical path database, which configuration will be explained later. If there is not a plan of the medical services influenced by the modification, to be conducted after the original scheduled date (“No” on S23), a process of S24 is conducted.

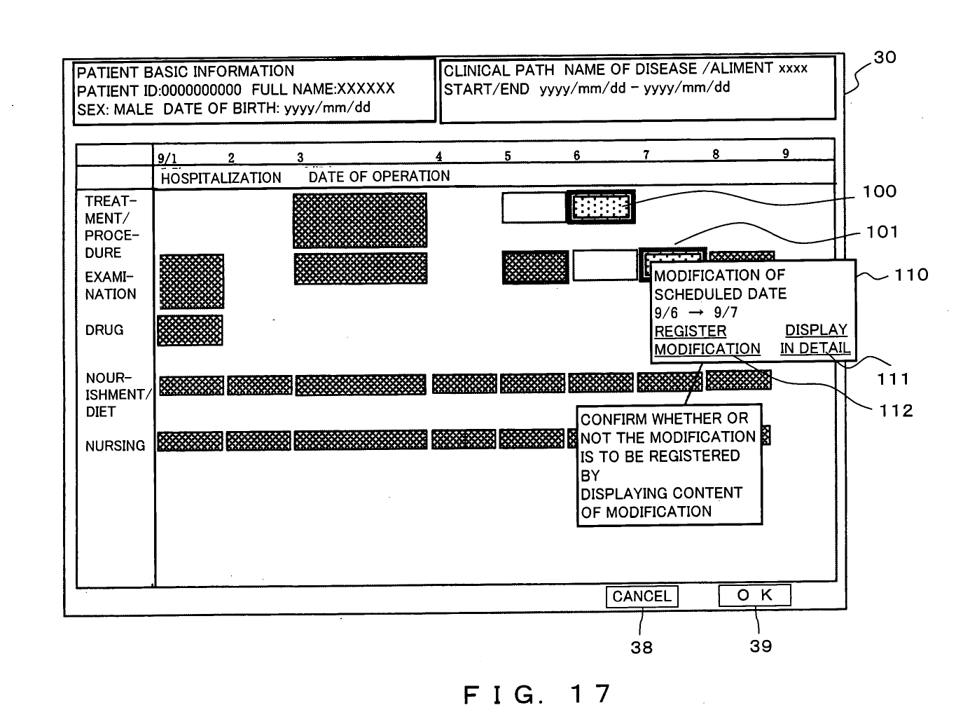

Thereafter, when it is determined that there is a plan of medical service being influenced by the modification on S23 (“Yes” on S23), the influenced medical service is displayed by changing a color of the words or by highlighting the words. Then, the contents of delaying or advancing of the schedule of the influenced medical service are automatically displayed based on the modified “Scheduled date” 64 (S25), which process will be explained in FIG. 16.

FIG. 16 shows a displayed state of the medical services being influenced by the modification of the “Scheduled date” 64 of FIG. 15. In FIG. 16, the “Treatment/Procedure” and the “Examination” among the medical services are influenced. As for the “Treatment/Procedure”, the “Scheduled date” 64 before modification has been set to be September 5 (FIG. 15), however, the scheduled date is displayed, in a highlighted manner, on a portion of September 6 being shifted by one day after the modification (S26). Also, at this moment, the modification to September 6 is not yet registered and on the window it is indicated to the user that the modification to September 6 is the most minor modification. As for the “Examination”, the modification from September 6 to September 7 (101) is prompted in the same manner.

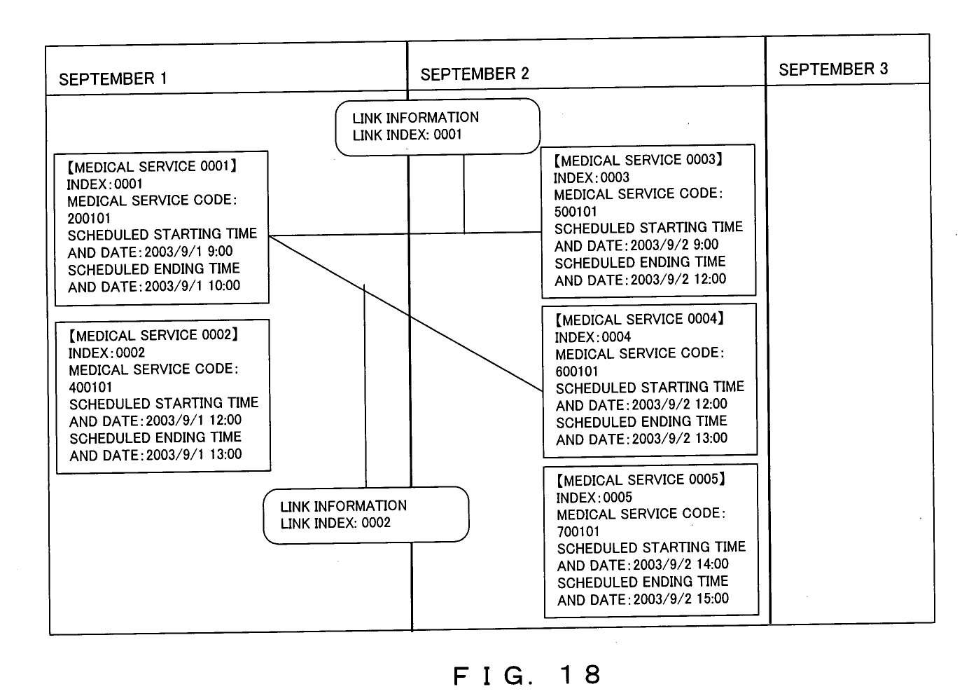

Next, a process for registering these unregistered scheduled dates of medical services have to be executed. For this purpose, a massage as shown in FIG. 17 is displayed when the right mouse button is clicked after selecting the “Examination” (101) by a mouse, for example.

FIG. 17 shows a massage window 110 for registering the contents of modification of the medical service influenced by the modification. The massage window comprises “Modification of scheduled date” showing the scheduled date before the modification and the scheduled date after the modification (not registered), a “Register modification” button 112 and a “Display in detail” button 111. If the automatically modified contents and schedule satisfy the user (“Yes” on S27), the “Register modification” button 112 is pressed so that the above contents and schedule are registered as they are. If it is needed that the detail of modification is confirmed or modified (“No” on S27), the “Display in detail” button 111 is pressed so that the “Input of order” window 61 is opened and the detail of the modification is confirmed or modified (S28).

After confirming all of the contents of modification by repeating the processes of S26, S27 and S28, the process of S24 is started.

Next, the operator determines whether or not there are other modifications (S24) and if there is any, the processing goes back to S21 in order to repeat the above processes. When there is not other modification, the operator presses the “OK” button 39. Then, the set clinical path information 65 is transmitted to the clinical path database server 3 so that the clinical path information 65 is registered in the clinical path database server 3.

Thereafter, as explained in the flowchart of FIG. 10, the order managing server 4 transmits to the linked department subsystems the modification order about all of the modified medical services.

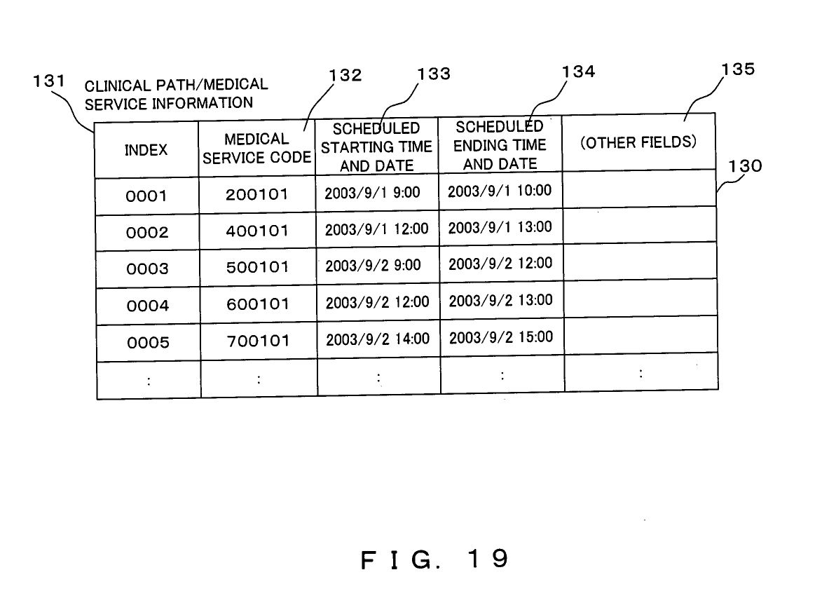

By the way, a method, on S23 of FIG. 14, for determining whether or not one modification of a medical service causes another modification of the medical services to be conducted after the one modification is explained in detail based on FIGS. 18 to 20.

FIG. 18 shows only the information regarding the linkages of medical services by extracting a portion from the clinical path. The medical services “0001”, “0002”, “0003” and “0004” are recorded on a clinical path-medical service information table 130 shown in FIG. 19.

FIG. 19 shows the clinical path-medical service information table 130. The clinical path-medical service information table 130 is a table stored in the clinical path database server and is created based on the clinical path information 65 transmitted from the hospital information system terminal 2. On the clinical path-medical service information table 130, the information regarding the medical services included in the subject clinical path is stored.

Each record of the clinical path-medical service information table 130 comprises “Index” 131 for medical service, “Medical service code” 132, “Scheduled starting time and date” 133, “Scheduled ending time and date” 134 and a group of fields 135 for storing other information.

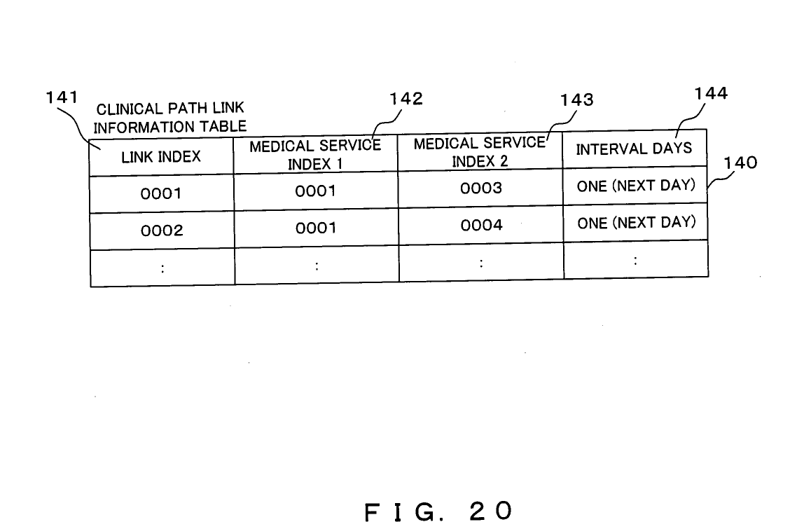

On the other hand, link information 0001 and 0002 in FIG. 18 are recorded on a clinical path link information table 140 shown in FIG. 20.

FIG. 20 shows a clinical path link information table 140. On the clinical path link information table 140, a “Link index” 141 for linking medical services, a “Medical service index 1” 142, a “Medical service index 2” 143 for indicating two medical services linked with each other by the “Link index” 141 and an “Interval days (or Interval hours)” 143 needed between the two medical services are recorded.

In FIG. 18, a medical service 0003 scheduled to be implemented at 9:00 on September 2 and a medical service 0004 scheduled to be implemented at 12:00 on September 2 are linked with a medical service 0001 scheduled to be implemented at 9:00 on September 1 respectively as a link index “0001” and a link index “0002”. However, medical services 0002 and 0005 are not linked with any other medical service. Therefore, the medical services 0002 and 0005 are independent from other medical services so that the medical services 0002 and 0005 can be modified freely.

When it is desired to delay the starting time and date of the medical service 0001 by one day, the following processes are conducted. Firstly, the starting time and date of the medical service 0001 is modified to 9:00 on September 2. Then, the controlling unit of the hospital information system terminal 2 inquires the clinical path database server 3 regarding the modification. The controlling unit of the clinical path database server 3 receiving the above modification inquiring information (for example, data of the modified index, modified medical service code, a scheduled starting time and date after modification and the like are included) conducts a search to find whether or not the medical service corresponding to the “Medical index 1” 142 i.e. the medical service index 1 “0001” is included in the clinical path link information table 140.

In this case, when the “Medical service index 1” is “0001”, two records of the linex 0001 and the link index 0002 correspond and the contents of the medical service of the “Medical service index 2” 143 of each record is checked to find 0003 and 0004 as the “Medical service index 2”. Then, the contents of the “Medical service index 2” 0003 and 0004 are checked based on the clinical path medical service information table 130 to find that the “Scheduled starting time and date” 133 of the two “Medical service index 2” are respectively “September 2” and the “Number of interval days” of them are respectively “1” (that is, next day).

The scheduled starting time and date of the medical service 0001 is modified to September 2 so that the result that there are not necessary interval days between the actual medical services, i.e. between the medical service 0001 and the medical service 0003 and between the medical service 0001 and the medical service 0004 is obtained.

In order to absorb the above disadvantage, the controlling unit of the clinical path database server 3 delays the scheduled starting time and date and the scheduled ending time and date of each of the Medical services 0003 and 0004 respectively by each number of days indicated as “Number of interval days” 144.

In the above case, the scheduled starting time and date and the scheduled ending time and date of each of the medical service 0003 and the medical service 0004 are delayed by one day so that “Scheduled starting time and date: Sep. 3, 2003 9:00” and “Scheduled ending time and date: Sep. 3, 2003 12:00” regarding the medical service 0003, and “Scheduled starting time and date : Sep. 3, 2003 12:00” and “Scheduled ending time and date : Sep. 3, 2003 13:00” regarding the medical service 0004 are set. Upon this processes, these changes are temporally stored in a working area of the storing unit of the clinical path database server 3. Thereafter, the above temporally stored information is returned to the hospital information system terminal 2 as modification inquiring result information.

The controlling unit of the hospital information system terminal 2, upon receiving the modification inquiring result information, reflects and displays the information on the “Clinical path detail information” column 33 of the “Clinical path” displaying window 30 (FIG. 16).

By the above processes, a series of medical services for a patient can be planed based on a clinical path and the orders can be transmitted to responsible departments of each medical service at a time of the input of the plan. Therefore, repeated input operations of the order in each department can be reduced as much as possible so that the time for inputting of orders can be saved.

Further, because a clinical path is prepared based on a model clinical path so that a plan of a series of medical services can be referred to in time series. Therefore, the mistakes of input and the input omissions can be reduced. Also, the modifications of a clinical path can easily be reflected on the system of each department so that mistakes of takeover of the notandums are avoided. Further, a unitary management of the medical services for one patient can be realized based on a clinical path.

Therefore, according to the present invention, a series of medical services for a patient can be unitarily managed based on a clinical path so that modifications of orders can be easily reflected on the systems of each department by one input operation. Accordingly, the time for inputting of orders can be saved. Further, repeated input operations can be avoided so that the mistakes of input and the input omissions of orders can be reduced.

### SECOND EMBODIMENT

A hospital information system according to a second embodiment of the present invention comprises:

a holding unit for holding clinical path standardized information which is progress information regarding a standardized medical service toward the target set for each of medical cases, being constituted of a plurality of medical service information each indicating a schedule regarding the medical service for a patient,

a clinical path information for each of patients obtaining unit for obtaining clinical path information for each of patients which is created based on the clinical path standardized information;

a creating and transmitting unit for creating and transmitting order information ordering that the medical service is to be implemented from the medical serviced information included in the clinical path information for each of the patients; and

an implementation result information obtaining unit for obtaining the implementation result information indicating the implementation result of the medical service implemented based on the order information.

Thanks to the above configuration, content, the result of progress and the like of medical service for a patient can be managed easily and efficiently.

Further, the hospital information system according to the second embodiment of the present invention further comprises:

a standardized implementation comparing unit for comparing the clinical path standardized information with the implementation result information; and

a standardized implementation comparison notifying unit for notifying result of comparison by the standardized implementation comparing unit.

Thanks to the above configuration, a comparison can be made between standardized progress information and information of actual progress so that occurrence of a variance can be easily recognized.

Further, the hospital information system according to the second embodiment of the present invention further comprises:

a difference related information obtaining unit for obtaining difference related information which relates to difference between the clinical path standardized information and the implementation result information.

Thanks to the above configuration, information regarding a factor causing variance can be obtained.

Further, in the hospital information system according to the second embodiment of the present invention:

the difference related information is created by a mobile terminal.

Thanks to the above configuration, information regarding a factor causing variance can be input via a PDA.

Further, in the hospital information system according to the second embodiment of the present invention:

the difference related information includes at least one of information regarding a factor causing the difference between the clinical path standardized information and the implementation result information, information regarding analysis of the factor and information regarding solution for the factor.

Thanks to the above configuration, information regarding a factor causing variance, information regarding analysis of the factor and information regarding solution for the factor can be obtained.

Further, the hospital information system according to the second embodiment of the present invention further comprises:

an implementation result information among patients comparing unit for comparing among the implementation result information of a plurality of patients based on the same medical case; and

an implementation result information among patients comparison notifying unit for notifying result of comparison by the implementation result information among patients comparing unit.

Thanks to the above configuration, clinical paths of a plurality of patients having the same medical case can be compared with one another.

Further, the hospital information system according to the second embodiment of the present invention further comprises:

a reflecting unit for reflecting, on the clinical path standardized information, the comparison result by the implementation result information among patients comparing unit.

Thanks to the above configuration, the clinical paths of a plurality of patients having the same medical case can be compared and the result of the comparison can be reflected on the standardized progress information as a feedback so that more accurate standardized progress information can be created.

Further, in the hospital information system according to the second embodiment of the present invention:

the implementation result information among patients comparing unit compares the clinical path standardized information and the implementation result information of each of patients.

Thanks to the above configuration, the clinical paths of a plurality of patients having the same medical case can be compared and the result of the comparison can be reflected on the standardized progress information as a feedback so that more accurate standardized progress information can be prepared.

Hereinafter, the second embodiment is explained.

The second embodiment of the present invention is characterized in that the outcome in course of the treatment by the clinical path and the medical services actually implemented for a patient are recorded as the implementation record in a mobile terminal, and the comparison and the analysis thereof are made by the system so that the labor of recording operation by a nurse is reduced and the variance can be recognized objectively. Hereinafter, the present embodiment is explained in detail.

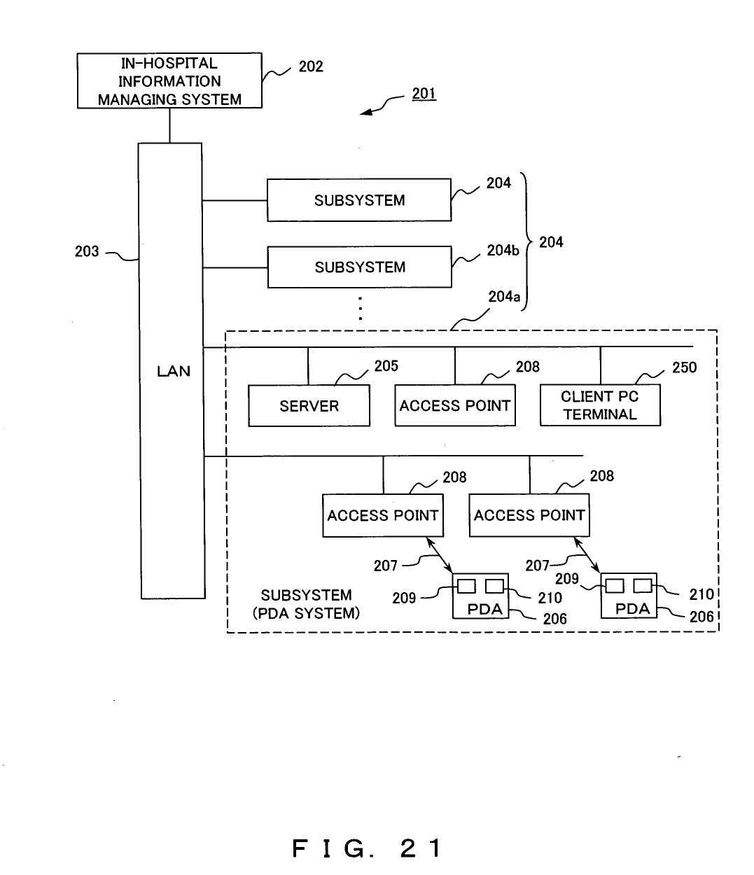

FIG. 21 is a block diagram showing an entire configuration of a hospital information system in an embodiment of the present invention. As shown in FIG. 21, a hospital information system 201 is arranged in a medical facility such as a hospital for example. The hospital information system 201 comprises an in-hospital information managing system 202 for recording and unitarily conducting a centralized management of information in the hospital and one or a plurality of subsystems 204 (204a, 204b, 204c, . . . ) being connected to the in-hospital information managing system 202 via, for example, a wired LAN (Local Area Network) 203 for conducting transmissions of information via the LAN 203.

Each of the subsystems (hereinafter, referred to as PDA system because the subsystem uses PDA) 204 comprises a server 205 for conducting information processing regarding a control of transmission of information with PDAs 206 and regarding a clinical path, a client PC terminal 250 which can modify the clinical path based on a result of comparison and analysis by a doctor or a nurse, a mobile terminal (for example, a PDA (Personal Digital Assistants)) 206 which can be carried and used by a medical staff (for example a nurse) and an access point 208 which is a data transmitting/receiving unit and enables an access from the PDAs 206 via a wireless LAN 207. The server 205, the client PC terminal 250 and each access point 208 are connected to one another via the wired LAN 203.

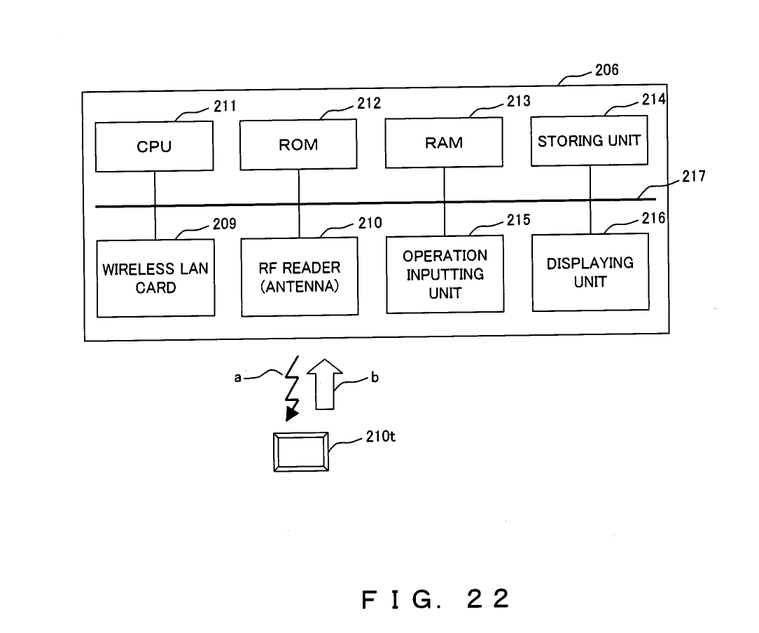

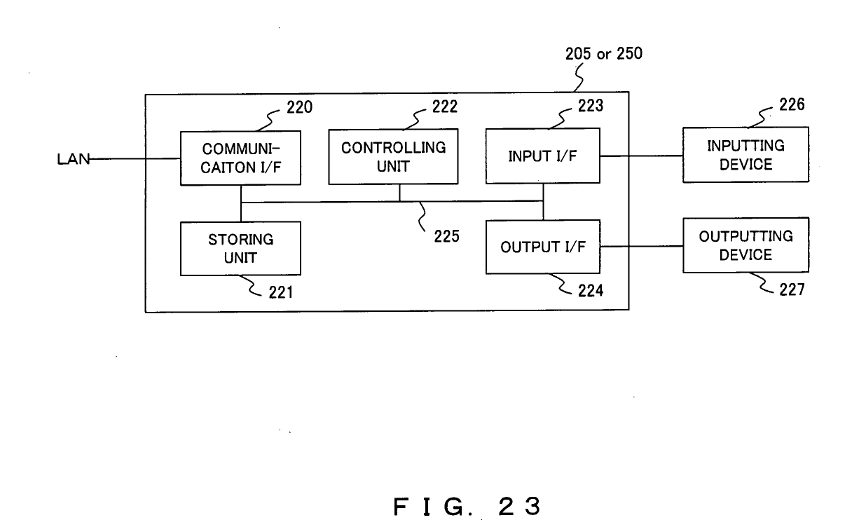

The PDA 206 incorporates a wireless LAN card 209 (See FIG. 22) which is a data inputting/outputting unit for enabling a wireless communication with the server 205 via the access point 208 by a wireless LAN 207, and a RF (Radio Frequency) reader 210 (See FIG. 22) for conducting a communication in a radio frequency bandwidth as a reading unit (device) for a distinction information.

FIG. 22 shows a hardware configuration of the PDA 206. In FIG. 22, the wireless LAN card 209, the RF reader 210, a CUP (Central Processing Unit) 211, a ROM (Read Only Memory) 212, a RAM (Random Access Memory) 213, a storing unit 214, an operation inputting unit 215 and a displaying unit 216 are connected with one another via a bus 217 so that the data transmission/reception is conducted there among under a control of the CPU 211.

The wireless LAN card 209 enables a data communication, with the server 205 of the subsystem 204, of characters, images and any other of data by a wireless communication via the access point 208, as a base station arranged in each of various places in the hospital.

The RF reader 210 can conduct a contactless communication with a RF tag 210t in a range of several centimeters to several meters which range is in accordance with an intensity of radio wave being able to be set arbitrarily. The RF reader 210 can read data from a memory in the RF tag 210t by the above contactless communication and can write data in the memory.

The RF tag 210t is configured, for example, as a flexible tip of about 4 square millimeters and protected by a thin film and comprises a CPU, a memory, an antenna, an emf circuit (not shown) and the like so that the emf circuit generates electricity responding to a prescribed radio wave “a” in radio frequency bandwidth from the RF reader 210. The CPU operates on that electromotive force in order to transmit the data “b” in the memory to the RF reader 210.

The CPU 211 is a central processing unit for controlling the entire operations of the PDA 206. The ROM 212 is a memory in which a basic control program executed by the CPU 211 is stored in advance so that the CPU 211 executes the basic control program upon starting the PDA 206. Thereby, the CPU 211 conducts an entire and basic control of the PDA 206.

The RAM 213 is used for a work memory when the CPU 211 executes various application programs stored in the storing unit 214, and also is used as a main memory for temporarily storing various data as needed.

The storing unit 214 is a memory for storing and holding various application programs and data. For the storing unit 214, semiconductor memories such as EEPROM (Electrically Erasable and Programmable Read Only Memory) or the like are suitable. Especially, the EEPROM is suitable because the stored contents can be modified electrically on the EEPROM, and also the electric supply is not needed for holding the stored contents.

The operation inputting unit 215 is a touch panel provided in, for example, the displaying unit 216. The operation inputting unit 215 is operated by a user of the PDA 206 and detects the operation contents thereof in order to transmit the operation contents to the CPU 211. The CPU 211 recognizes the contents of instruction by the user corresponding to the operation contents. The displaying unit 216 is, for example, a liquid crystal display and visually supplies various information to a user by displaying the various information transmitted from the CPU 211.

The input and output of various data among the above RF reader 210, the operation inputting unit 215 and the displaying unit 216 can be conducted by a prescribed application program executed by the CPU 211. As described above, the PDA 206 comprises a wireless LAN 207 so that the PDA 206 can access to the in-hospital information managing system 202 via a server 205 at an arbitrary place within an access range of the PDA, obtain the medical order and display the obtained medical order on the displaying unit of the PDA 206, although the access range within which the communication can be conducted is limited in accordance with the distance from the access point 208.

Further, by enabling a simultaneous read of the distinction information of a plurality of kinds of RF tags 210t upon the read of the distinction information of RF tags 210t used in a wide area with the PDA 206 comprising the RF reader, a nurse or the like carrying the PDA 206 can input (or read) the distinction information such as ID of implementing person, ID of patient for which medical service is implemented, ID of injection and the like precisely, easily and rapidly.

The information in the RF tags 210t are simultaneously read without a sequentiality and can be read randomly. Based on the distinction information read randomly, the information managing server terminal is inquired in a hospital and the inquiry result is displayed on a screen of the PDA 206.

Also, the PDA 206 has a water proofed structure against liquid medication so that the PDA 206 can be easily handled in a medical site.

Thereby, especially in a nurse system and a ward system in which nurses implement medical services, each nurse carries the PDA 206 so that the medical service information can be input and output at a place of the implementation of the medical service, specifically by a bed of the inpatient. Thereby, the situations of medical services can be recorded and grasped in a real time. In other words, the medical services can be precisely recorded and grasped in a place of implemented medical services without a delay from the time at which the medical services are implemented.

Also, when medical services are implemented at a place of the implementation of the medical service, the contents of the scheduled medical services can be confirmed by the PDA 206 so that the medical services can be implemented after the confirmation of the contents of the scheduled medical services. Thereby, the medical services to be implemented (scheduled medical services) can be implemented precisely and with lowered possibilities of mistakes.

Also, thanks to the use of the PDA 206, the record of the contents of implemented medical services can be input at the place of the implementation of the medical service so that the implemented medical services can be recorded at the place of the implementation having the confirmation of the contents thereof immediately after the implementation. Therefore, the medical services can be recorded precisely and with lowered possibilities of mistakes.

Also, upon the implementation of the medical services, thanks to the use of the PDA 206, the scheduled contents of the medial services can be easily referred to and confirmed at an almost arbitrary place and time so that the implementation of the medical services are facilitated. Further, in case that the scheduled contents are modified, it is easy to meet the modification because the confirmation of the scheduled contents can be conducted at the place of the implementation immediately before the implementation.

Also, in case that the medical services are implemented in the above manner, the contents of the implemented medical services can be recorded precisely and in a real time so that the system can be improved more suitably by analyzing the recorded data.

The information implemented in the PDA 206 as above can be confirmed on the client PC terminal 250 and the registered contents on the PDA 206 can be modified on the terminal 250 as needed. This configuration functions in case that there occurs a mistaken input of the implementation registration, and the modification history can be recorded upon the modification.

Also, the client PC terminal 250 can also batch-process, as the order which can be implemented in the PDA 206, the medical cases registered as the standard treatment. Specifically, because the client PC terminal 250 has a larger display area on the screen than that of the PDA 206, a plurality of the input items can be displayed simultaneously. Therefore, the implementation result to be input as one group (for example, temperature, blood pressure, pulse of a patient and the like) to some extent, these items can be input all together.

Also, in the inputting window as above, the complicated settings are not necessary and only an easy operation such as specifying a clinical path is required so that the burden on a user is reduced. As a matter off course, a minor adjustment can be conducted in accordance with a patient. Note that detailed descriptions of an ordering function of a clinical path is omitted now.

FIG. 23 shows a hardware configuration of the server 205 and the client PC terminal 250. In FIG. 23, the configuration comprises a controlling unit (CPU) 222 for conducting processes and calculations by programs, a storing unit 221 for storing necessary data, an input interface (hereinafter “interface” is referred to as “I/F”) 223 for connecting inputting devices such as below for inputting the order, data, or the like by the inputting devices 226 such as a mouse, a keyboard, mobile terminal and the like, an output I/F 224 for connecting the above devices for outputting the data to outputting devices 227 such as a printer, a display and the like, a communication I/F 220 as an interface for connection with a network such as LAN or the like, and a bus 225 for connecting the above components.

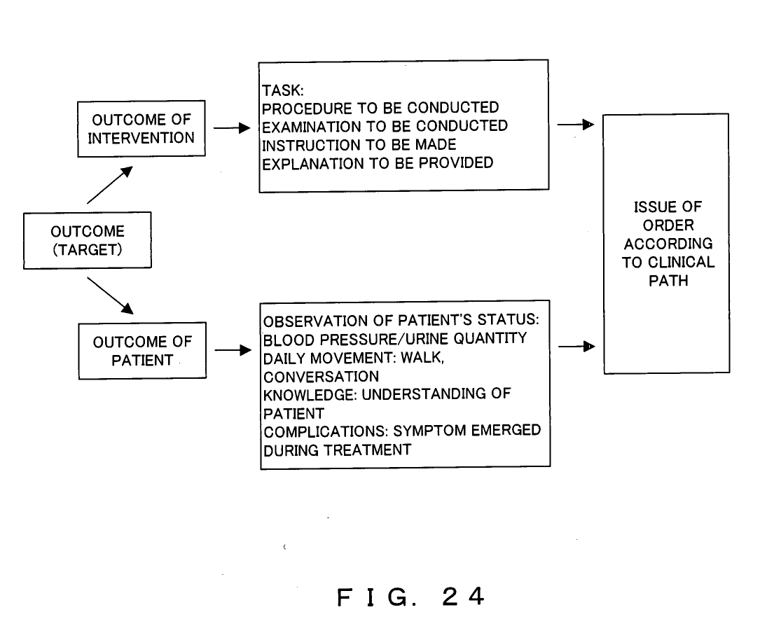

FIG. 24 shows a concept based on which an implementation order of patient progress information are created from a classification of outcomes (targets). Each clinical path is set for each medical case and each target (outcome) is generated in accordance with the clinical path based on the above setting. In order to realize the outcome, there are concepts of outcome of intervention and outcome of patient.

The outcome of intervention means contents implemented for a patient (tasks: for example, procedure to be conducted, examination to be conducted, instruction to be made or explanation to be provided). The outcome of patient means information obtained from a patient as a result of the outcome of intervention (for example, Observation of patient's status: blood pressure/urine quantity, Daily movement: walk, conversation, Knowledge: understanding of patient, Complications: symptom emerged during treatment).

The information of the outcome of intervention is created before the issue of the order because the information is the content to be implemented. And the outcome of patient is for inputting the result information of implemented medical service so that only the input items thereof are created before the issue of the order.

Being based on the above configuration, each clinical path is set for each medical case and the items such as task, patient's status, daily movement, knowledge, complications are created so that each order for each item is created. Upon the above, the order can be automatically created at a time when a clinical path for a medical case is selected.

A nurse takes the created order in the PDA 206 and conducts an implementation registration of patient's status as the patient progress information by a bed of the patient, based on the above order information taken in the PDA 206. The implementation registration is conducted for each of items based on a list of necessary items for progress information of a patient, displayed on the displaying unit 216 of the PDA 206, and the operation inputting unit 215 recognizes the implementation registration data when the display unit 216 is tapped by an attached touch pen or the like, for example, in accordance with a message of the displaying unit 216.

Thereafter, the implementation registration data, utilizing real time communication function, is registered in the server 205 via the wireless LAN card 209, the wireless LAN 207, the access point 208, and the LAN 203. The implementation registration data on the PDA 206 can be confirmed on the client PC terminal 250 and can be modified on the terminal 250 if needed.

Also, the orders to be implemented are issued by the client PC terminal 250 and can be taken in the PDA terminal 206 for each patient or for each ward. When the implementation registration of the order taken in the PDA 206 is conducted, the order is registered in the server 205 in a real time. As for the order of a clinical path, variance differences are compared between the order and a standardized progress information for indicating one of “Good”, “Bad” or “No problem” so that the comparison result is notified to the PDA 206. The detailed confirmation can be conducted also on the client PC terminal 250.

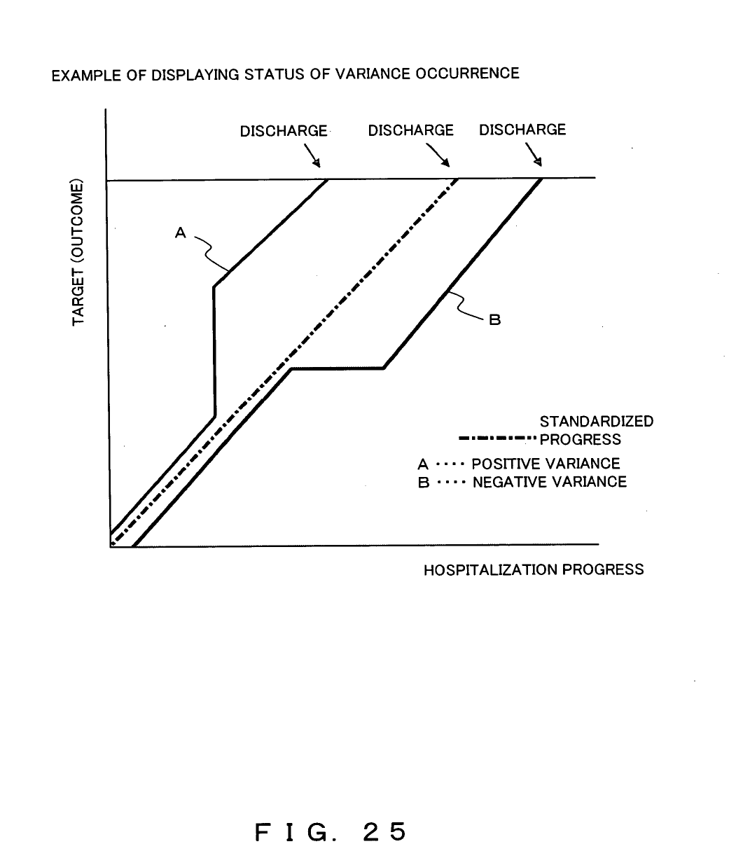

FIG. 25 shows an example displaying the difference of outcomes between the standardized progress information and patient progress information. The graph in FIG. 25 is displayed on a window of the client PC terminal 250. In FIG. 25, it is clearly found whether the patient's status is changed to a better status (the line A) or it is changed to a worse status (the line B) in comparison with the standardized progress (dashed line) thanks to the implementation of clinical path so that the plan toward the discharge is easily prepared.

Conventionally, the evaluation of the patient progress information had to be conducted by printing the information on a sheet of paper or the like after the implementation of a clinical path. However the result of implementation on the PDA 206 can be processed on the server 205 and the result can be returned to the PDA 206, and further, the status can be easily grasped on the client PC terminal.

Thanks to the above, the report of the treatment result can be objectively explained to a patient so that the informed consent can be easily realized. Also, when, for example, a configuration is also possible that when a person in a position to make instructions of medical services such as a doctor or the like uses the PDA 206, the modification of a clinical path can be conducted on the PDA 206 which have received the notification.

Further, when it is desired to modify a clinical path for a patient because of a variance, the clinical path can be reviewed. Upon this, it registered how the clinical path is reviewed by using a variance occurrence classification list which will be described below. The registered contents are stored as a countermeasure list for variance. The countermeasure list for variance can be used as a reference for creating a standardized progress information because the countermeasure list for variance clarifies the tendencies of the responses.

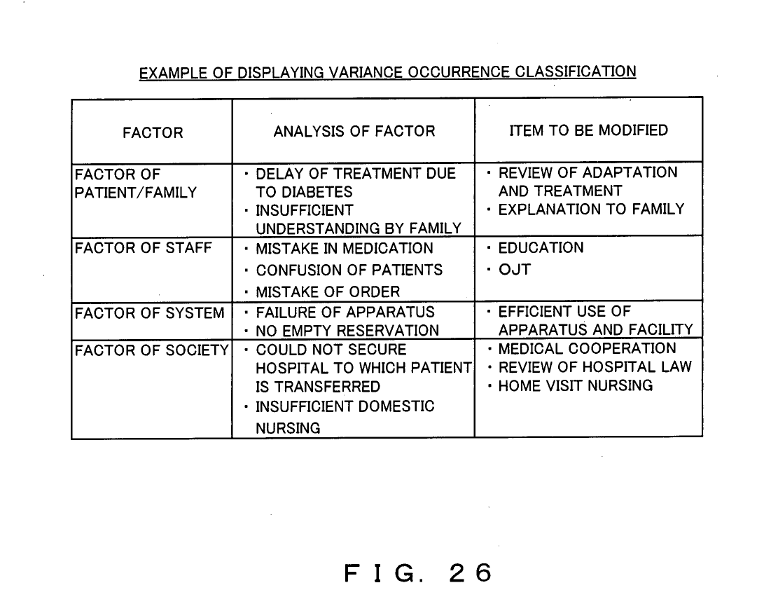

FIG. 26 shows the variance occurrence classification list. The operations for creating this list are not particularly shown. When the outcome is reviewed because of the occurrence of variance, the variance occurrence classification list is displayed on the displaying unit 216 of the PDA 206 so that the cause and the countermeasure are registered by selecting the corresponding item on a pull down menu. Further, the item which is not included in the pull down menu can be registered in addition.

The modifications of a clinical path are sequentially accumulated as data in the server 205. In the server 205, all of the information in the hospital is unitarily managed so that the reference to other clinical path and the comparison with the other clinical path can be easily conducted.

By referring to other patient progress information of the same medical case, the medical services implemented for the present patient can be objectively compared with the above other information in order to find whether or not the present medical services are reasonable. Further, in case that a plurality of the same clinical paths are compared to one another and there are similar differences in the plurality of the patient progress information from a present standardized progress, the patient progress information having the difference are thought to be reasonable progress value. In such a case, the master standardized progress information can be modified so that more accurate clinical paths can be prepared.

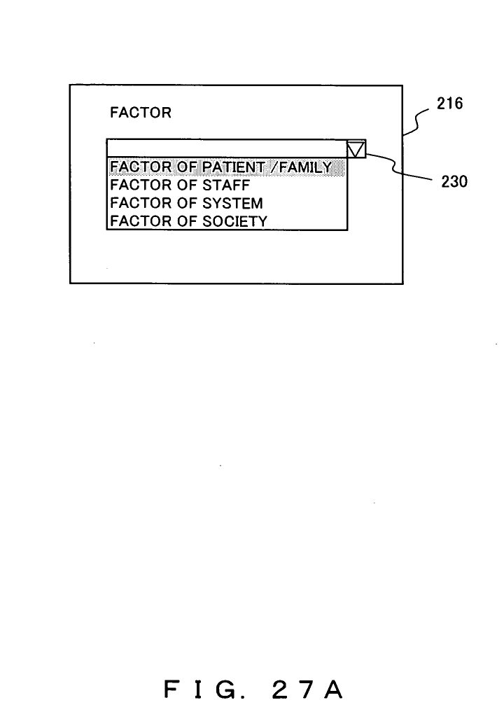

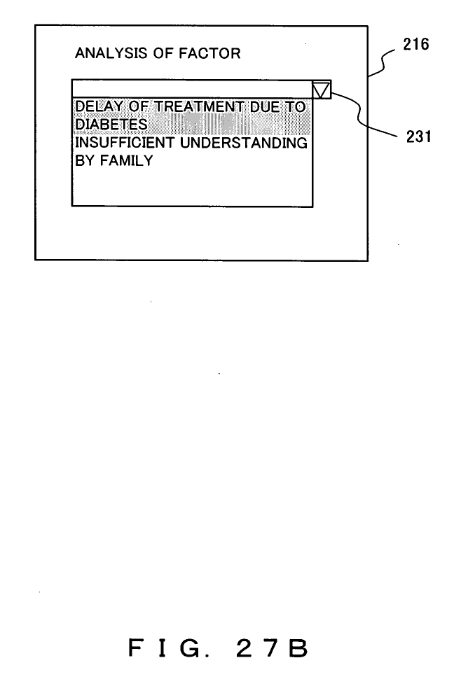

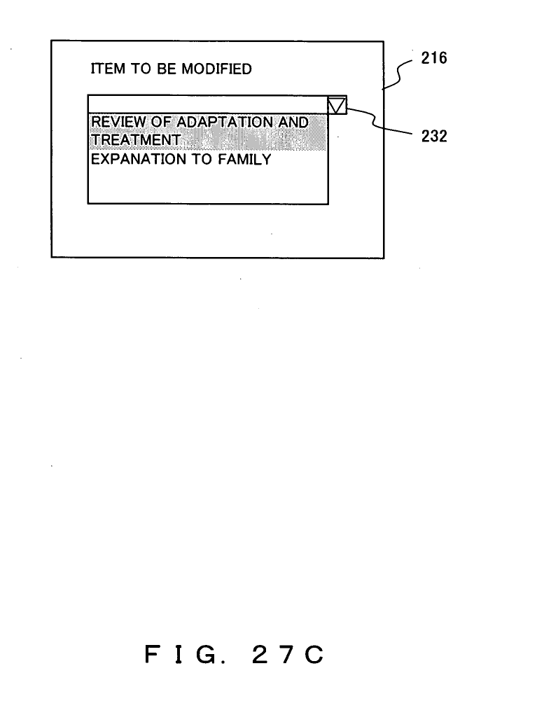

FIG. 27 shows a menu for selection of the variance occurrence classification list on the PDA 206. When the “Variance occurrence classification” is selected on a menu window by operating the PDA 206, a window for selection of a factor included in a variance occurrence classification is opened (See FIG. 27A).

The “Factor” is selected from a list item 230 displayed on a window of FIG. 27A. For example, when “Factor of patient/family” is selected, a window is opened to select a “Analysis of factor” included in the variance occurrence classification (See FIG. 27B).

The “Analysis of factor” is selected from a list item 231 displayed on a window of FIG. 27B. For example, when “Delay of treatment due to diabetes” is selected, a window is opened to select a “Item to be modified” included in the variance occurrence classification (See FIG. 27C).

The “Item to be modified” is selected from a list item 232 displayed on the window of FIG. 27C. For example, when “Review of adaptation/treatment” is selected and an “OK” button (not shown) is pressed, information of the “Factor”, “Analysis of factor” and “Item to be modified” is transmitted to the server 205 in order to be stored in the server 5.

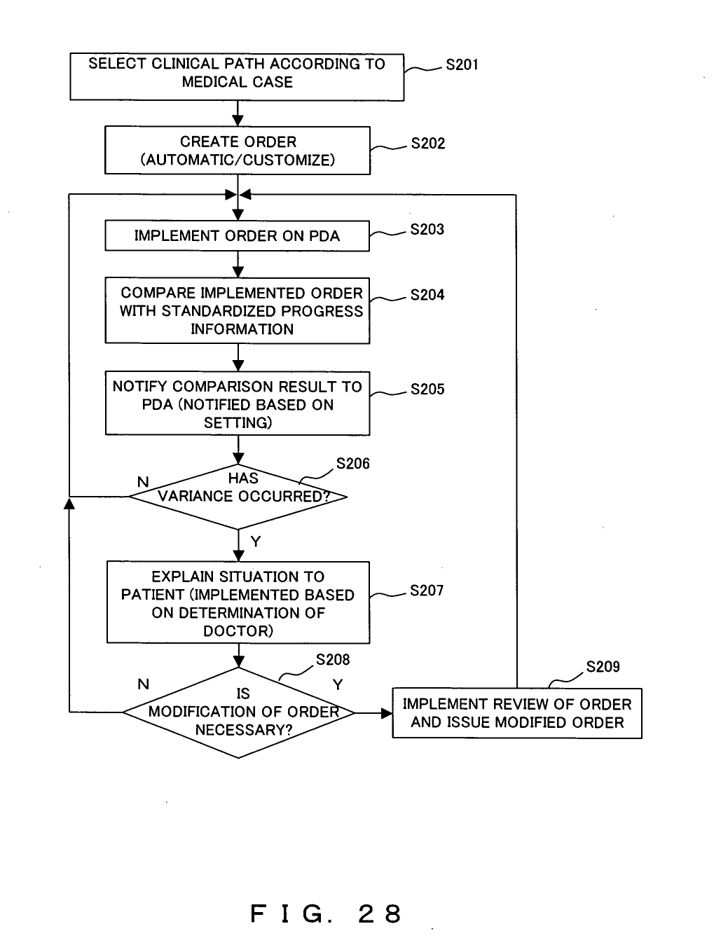

FIG. 28 shows a flowchart for processes from the issue of order to the review of the order. In S201, when a clinical path can be applied in accordance with the actual medical case of a patient, a clinical path is selected. In S202, the order is automatically created based on the clinical path. Upon this, patient basic information (age, sex, state of health) are taken into consideration for the creation, however, a person in a position to make instructions of medical service such as a doctor can customize the order if needed.

In S203, the medical services are implemented based on the issued order on the PDA 206. In S204, the comparison of the implemented order is conducted in the server 205. The above comparison of the implemented order is conducted with a basic progress information held in the server 205.

In S205, the result of the comparison in S204 is notified to each PDA 206. Also, the above result of comparison is notified only to the PDAs 206 holding the patient information to which the clinical path is applied. The above result is not notified to PDAs 206 not having the linkage. Also the above result is notified to the client PC terminal 250 so that the responsible doctor confirms the result. Also, the manner for notification depends on the set value. For example, the notification can be conducted sequentially in accordance with the condition of a patient, or be conducted once a day in the stable term or be conducted when a variance occurs.

In S206, it is determined whether or not a variance has occurred, and when the variance has not occurred, the contents of the order are continued without conducting any operation. When a variance has occurred, an explanation is given to a patient of S207. Also, this explanation can be conducted based on a judgment by a doctor. In S208, when it is determined that the modification of the order is necessary based on condition of the patient, the review of the order is conducted in S209 so that the clinical path is implemented based on the new order. When it is determined that an observation of the progress is necessary for a while, the contents of the order without modification are implemented.

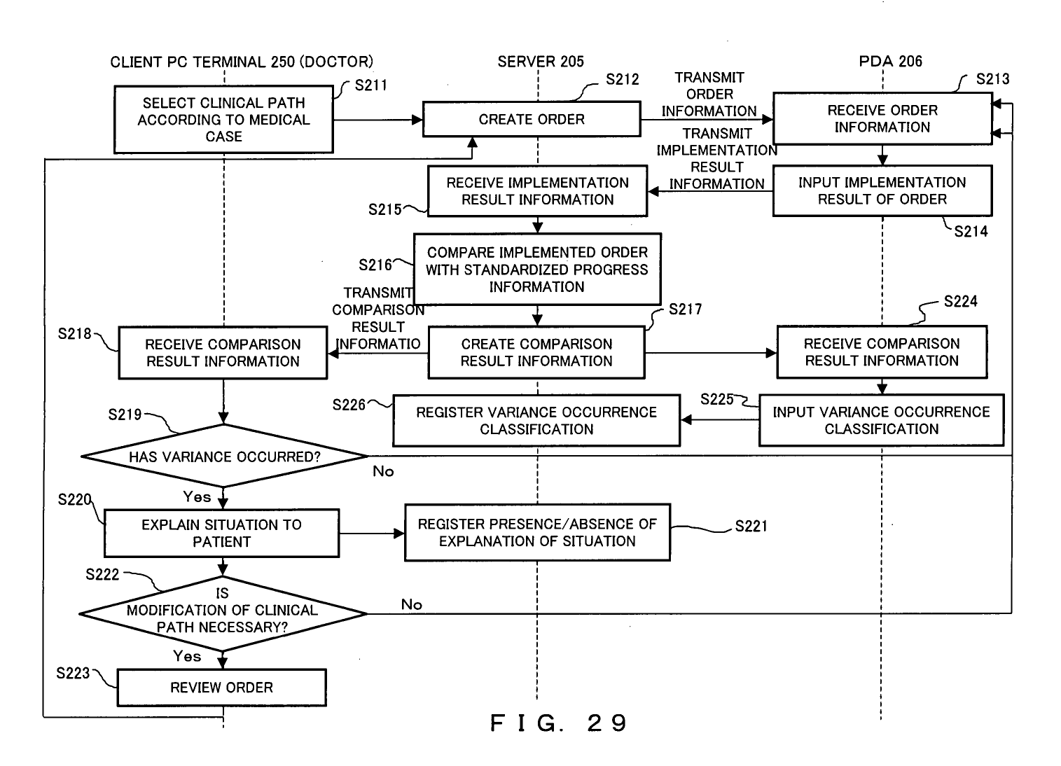

FIG. 29 explains in detail the flowchart of FIG. 28. The clinical path of the patient is input on the client PC terminal 250 by an operator (for example, a doctor, a nurse or the like). The operator activates a program according to the present invention which is installed in the client PC terminal 250 by an inputting device such as a mouse or the like.

The controlling unit 222 receiving the above order of activation reads the above program stored in the storing unit 221 in order to activate the program. When this program is activated, a menu window of a clinical path setting system is displayed on a display. The menu window includes a plurality of buttons for opening processing windows corresponding to processes of respective operations, and when a “Selection of a clinical path” button is selected out of the above buttons, a list for patient selection is displayed, thereafter, when a prescribed patient is selected on the list, a window for selection of a clinical path for the selected patient is opened.

On the window for selection of a clinical path, a clinical path can be selected in accordance with a medical case of the patient. When a clinical path is selected on the window, a window for setting a clinical path in detail for the patient (hereinafter referred to as a clinical path setting window) is opened. Upon this, the clinical path setting window obtains default data of the above selected clinical path from the server 205.

Now, the default data of the clinical path is explained. In the server 205, model data of a clinical path is stored in a prescribed area of a storing unit of the server 205 and the default data of the clinical path is transmitted to the client PC terminal 250 based on the default data. Default data of a clinical path means copied data of the model data of a clinical path, the initialized data about the selected clinical path and data consisting of standardized progress information of the above described clinical path.

The default data of a clinical path is configured as a schedule table including medical services such as treatment, examination, medication and the like in a combined state in order to include the information regarding the respective medical services implemented between the start and the end of the schedule, e.g. between the hospitalization and the discharge.

Again, the clinical path setting window is explained. On the clinical path setting window, detailed settings can be conducted regarding various medical services included in a clinical path (for example, treatment, examination and medication) (S211). Specifically, on the client PC terminal 250, more detailed information can be added about the obtained default data of the clinical path in accordance with each patient.

As for the medication for example, the kind, the amount, the term and the like of the medication can be set. When an “OK” button on the clinical path setting window is pressed after the setting, the input contents (hereinafter referred to as clinical path setting information) is transmitted to the server 205 and registered therein.

The server 205 receiving the clinical path setting information, extracts medical service information which is procedure information to be implemented for a patient included in the clinical path setting information in order to create medical service implementation instruction (order information) (S212). The created order information is transmitted to a PDA 206 of a nurse or the like responsible for that patient.

The nurse carrying the PDA 206 receiving the order information (S213) confirms the contents of the received order information and implements the medical services as ordered by the order information (such as temperature measurement, pulse measurement, blood pressure measurements medication and the like, for example) Thereafter, the result of the implementation (the temperature of the patient as the result of the temperature measurement, the blood pressure value and the like) is input in the PDA 206 in order to be transmitted to the server 205 (S214).

The server 205, upon receiving the implementation result information of the order (S215), compares the implemented order with the standardized progress information (S216). The comparison herein means a comparison between the standardized progress information (37 degrees) and the implementation result information (38 degrees) when the actual patient temperature is 38 degrees while the temperature of the standardized progress information is 37 degrees, in case of the patient's temperature in a day after an operation, for example. However, the subject and method of the comparison changed according to the implemented contents and are not limited. For example, the comparison can be conducted about the information regarding the body itself of a patient such as temperature, blood pressure or the like, or can be conducted regarding the period while which a slight fever continued.

Next, comparison result information of S216 is created (S217) so that the comparison result information is transmitted to the client PC terminal 250 and the PDA 206. The client PC terminal 250 and the PDA 206 receive the transmitted comparison result information (S218 and S224). On the client PC terminal 250, when the comparison result information is received, the standardized progress information and the actual progress information are displayed as a graph on a window as explained in FIG. 25. Also, for example, the standardized value by a clinical path and the actual measured value regarding respective medical services can be displayed in addition to the display of a series of progress information as in FIG. 25.

Also, on the displaying unit 216 of the PDA 206 receiving the comparison result information, information regarding difference between the standardized progress and the implemented result about the medical services is displayed regardless of the presence/absence of variance. For example, as for the above example of temperature measurement, the result of “Standardized progress information: 37 degrees, the implemented result information: 38 degrees, the variance: 1 degree” is displayed.

The nurse, after confirming the above contents, can input the variance occurrence classification explained in FIGS. 26 and 27 (S225). In other words, the nurse can input a factor of variance, analysis of factor and modified items corresponding to the implementation result. For example, in case that the actual temperature is 39 degrees while the temperature is expected to be 37 degrees in the clinical path, the nurse inputs the factor of variance, analysis of factor and modified items by the operations of FIG. 27 using the PDA 206. The information as above is transmitted to the server 205, being linked with the implementation result thereof in order to be stored in a prescribed area of the storing unit of the server 205 (S226).

By the way, a doctor viewing the result displayed on the client PC terminal 250 in S218 determines whether or not a variance has occurred (S219). When it is determined that a variance has not occurred in S219, the processing goes back to S213 so that the following processes are conducted as described above. When it is determined that a variance has occurred, the situation is explained to the patient (S220). The explanation of the situation to the patient is conducted based on the judgment of a doctor. Upon this, it can be registered in the server 205 by using the client PC terminal 250 whether or not the explanation was conducted (S221).

Next, the doctor determines whether or not the modification of the clinical path is necessary (S222) When it is determined that the modification of the clinical path is not necessary, the processing goes back to S213 so that the following processes are conducted as described above.

When it is determined that the modification of the clinical path is necessary, the doctor reviews the order (S223). Upon reviewing the order, the modifications such as that the medicated amount of drug are changed, kinds of drugs are changed or the like are conducted on the existing clinical path setting information in accordance with the condition of the patient. These modifications can be conducted on the clinical path setting window on the client PC terminal 250 in a same way as in S221.

When the clinical path setting information is modified on the clinical path setting window, the information is transmitted to the server 205 so that the clinical path information on the server 205 is updated. Thereafter, the processes following the above described S212 are conducted.

As described above, the schedule of medical services can be flexibly modified in accordance with the occurrence of variance so that the change of the condition of the patient can be easily met. Thereby suitable procedures can be conducted. Further, variance information regarding a plurality of patients about the clinical path setting information on the same medical cases can be collected in order to be compared with one another. Further, statistics of the above information can be kept in order to update the model data which served as the base of the clinical path setting information.

Specifically, when a procedure which is set to take three days in the model data and the value of four days is obtained based on the actually kept statistics, regarding one medical service of the clinical path setting information of one medical case, it is considered that the model data was inaccurately set so that by reflecting (i.e. by feeding back) the above statistically obtained information on the model data (standardized progress information), more accurate model data (standardized progress information) can be created.

From the above, the modification of the medical services on a clinical path can be recorded by the present system so that the burden for collecting data of medical services, the burden for grasping the contents of medical services, advancement, results and the like can be reduced.

Further, the variance can be recognized by comparing the recorded result and the outcome, a suitable modification of a clinical path can be easily conducted for a patient and the implementation result are accumulated as the record so that the accuracy of the standardization can be improved based on the accumulated data.

The collection, the accumulation and the analysis of data can be realized in a high accuracy thanks to the assistance by computer systems for a clinical path so that better medical services with improved quality, reduced days of hospitalization, standardized care, efficient use of medical resources and the like can be provided.

Therefore, by applying the present invention, modifications occurred on a clinical path can be recorded so that the burden for collecting data of medical services, the burden for grasping the contents of medical services, advancement, results and the like can be reduced.

Further, a variance can be recognized by comparing the recorded result with the outcome so that a suitable modification of a clinical path can be conducted easily for a patient and the implementation results are accumulated as a record. Thereby, the accuracy of the standardization can be improved based on the accumulated data.

The collection, the accumulation and the analysis of data can be realized in a high accuracy thanks to the assistance by computer systems for a clinical path so that better medical services with the improved quality, reduced days of hospitalization, the standardized care, efficient use of medical resources and the like can be provided.

### THIRD EMBODIMENT

A nursing and medical assisting device for assisting implementation of a medical service for a patient during treatment according to a third embodiment of the present invention comprises:

an implementation data obtaining unit for obtaining implementation data indicating content implemented as a medical service for the patient;

a medical schedule data obtaining unit for obtaining medical schedule data indicating a schedule of the medical service which is to be implemented for the patient;

a progress determining unit for determining whether or not, based on implementation data obtained by the implementation data obtaining unit and medical schedule data obtained by the medical schedule data obtaining unit corresponding to the obtained implementation data, a progress of the patient has deviated from the schedule indicated by the medical schedule data; and

a determination presenting unit for presenting determination result by the progress determining unit.

Further, in the nursing and medical assisting device according to the third embodiment of the present invention:

the determination presenting unit, when the progress determining unit determines that there is a deviation of a progress of the patient from the schedule indicated by the medical schedule data, can present a counter plan for the deviation.

Further, in the nursing and medical assisting device according to the third embodiment of the present invention further comprises:

a factor obtaining unit for obtaining a supposed factor input by the determination, by the progress determining unit, that there is a deviation of a progress of the patient from the schedule indicated by the medical schedule data.

Further, in the nursing and medical assisting device according to the third embodiment of the present invention:

when the supposed factor is selected from options or the supposed factor is input as comment based on the presented options of the supposed factor, the factor obtaining unit adds to the options the supposed factor input as obtained comment.

Further, a nursing and medical assisting method for assisting implementation of a medical service for a patient during treatment according to the third embodiment of the present invention comprises:

an implementation data obtaining step in which implementation data indicating content implemented as a medical service for the patient is obtained;

a medical schedule data obtaining step in which medical schedule data indicating a schedule of the medical service which is to be implemented for the patient is obtained; and

a progress determining step in which it is determined whether or not, based on implementation data obtained in the implementation data obtaining step and medical schedule data obtained in the medical schedule data obtaining step corresponding to the obtained implementation data, a progress of the patient has deviated from the schedule indicated by the medical schedule data.

Further, a computer data signal realized on carrier waves for assisting implementation of medical service for a patient during treatment according to the third embodiment of the present invention causes a computer to execute;

an implementation data obtaining process of obtaining implementation data indicating content implemented as a medical service for the patient;

a medical schedule data obtaining process of obtaining medical schedule data indicating a schedule of the medical service which is to be implemented for the patient;

a progress determining process of determining whether or not, based on implementation data obtained in the implementation data obtaining process and medical schedule data obtained in the medical schedule data obtaining process corresponding to the obtained implementation data, a progress of the patient has deviated from the schedule indicated by the medical schedule data; and

a determination presenting process of presenting determination result by the progress determining process.

Hereinafter, a third embodiment is explained.

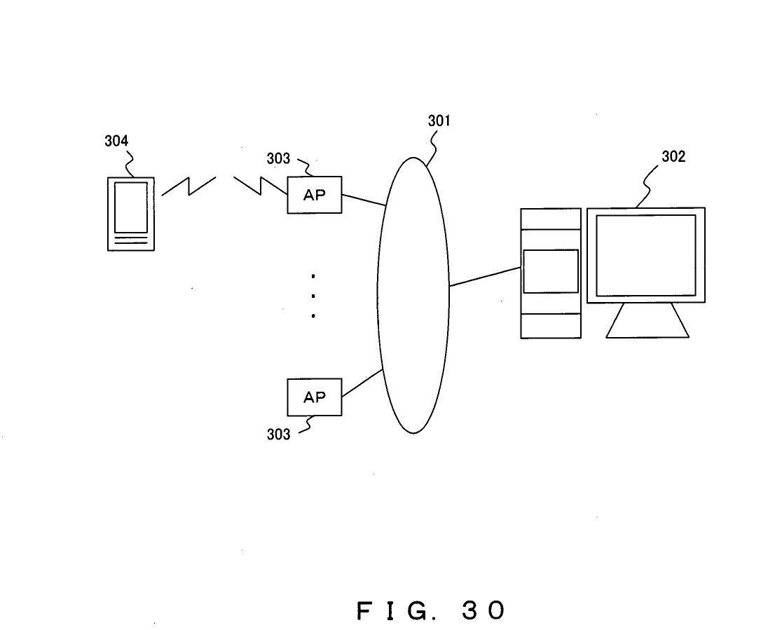

FIG. 30 shows a configuration of a hospital information system comprising a nursing and medical assisting device according to the present embodiment. The above information system is structured for conducting a team care in a medical facility such as a hospital in which system the information is shared by the persons engaged in the team care (doctors, nurses and the like).

As shown in FIG. 30, the information system is configured by an in-hospital information managing system (hereinafter, referred to as “managing system”) 302 structured for managing and creating various information, and a plurality of access points (AP) for conducting wireless communication 303, being connected to a communication network 301. The engaged person, upon contacting a patient, operates a terminal device 304 in order to access the managing system 302 via the AP 304 and the communication network 301. Thereby, the necessary information can be obtained and various information can be registered. The nursing and medical assisting device according to the present embodiment is realized in a form of being provided in the managing system 302.

The above communication network 301 is, for example, a LAN. The managing system 302 is, for example, a system structured by connecting a plurality of servers to one another. The terminal device 304 used by the engaged person is, for example, a highly portable tablet type personal computer which can conduct a wireless communication with the AP 303, or a PDA to access the managing system 302 in a place where the patient exists. The terminal device 304 can be directly connected to the communication network 301 although the device 304 which can conduct a wireless communication is shown in FIG. 30.

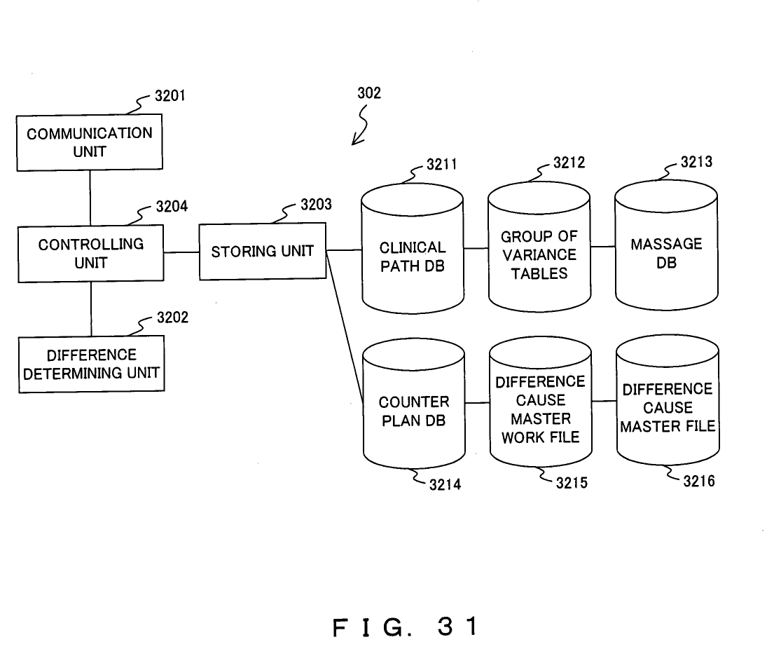

FIG. 31 shows a function configuration of the above managing system 302.

The above managing system 302 comprises, as shown in FIG. 31, a communication unit 3201 for communicating via the communication 301, a difference determining unit 3202 for determining whether or not there is a difference between a patient's progress and a schedule indicated by a clinical path, a storing unit 3203 for managing various databases (DB) and a controlling unit 3204 for entirely controlling the system 302. The difference determining unit 3202 and the controlling unit 3204 are realized by a configuration that the CPU provided in the server used for the construction of the managing system 302 uses the resource of the system and executes a program stored in a hard disk device or the like.

The storing unit 3203 manages a clinical path DB 3211, a group of variance tables 3212, a message DB 3213, a counter plan DB 3214, a difference cause master work file 3215 and a difference cause master file 3216. These components are explained below.

The clinical path DB 3211 stores data indicating the content for one clinical path indicating the schedule of the ideal medical services to be implemented for a patient. Various codes for the search key are assigned to respective clinical paths and stored. In the present embodiment, a clinical path is prepared for each one patient for the purpose of conducting more suitable medical services for a patient.

The group of variance tables 3212 comprises a variance table prepared for determining whether or not a difference between a patient's progress and a schedule specified by a clinical path, i.e. variance has occurred. Because different medical services are implemented based on respective clinical paths, each table is prepared for each one of the clinical paths.

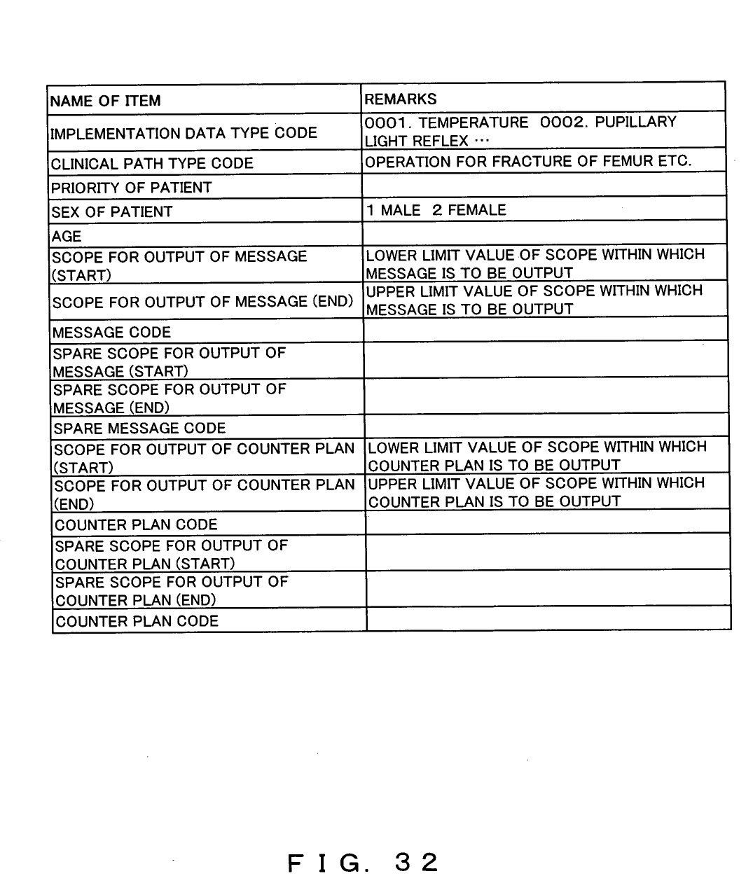

FIG. 32 explains a data configuration of a variance table. In the table such items as implementation data type code for indicating a kind of content (medical service) implemented based on a clinical path, a type code for indicating the clinical path, a property of a patient, a sex of the patient, age of the patient, a lower limit value of a scope within which a message is to be output (presented) (in FIG. 32 expressed as “Scope for output of message (start)” and hereinafter, referred to as “start value of message output scope”), an upper limit value of a scope within which a message is to be output (presented) (in FIG. 32, expressed as “Scope for output of message (end)” and hereinafter, referred to as “End value of message output scope”), a message code for indicating a message to be output, a lower limit value of a scope within which a message is to be output (presented) before a message specified by the above message code is output (presented) (in FIG. 32, expressed as “Spare scope for output of message (start)” and hereinafter, referred to as “Start value of spare message output scope”), an upper limit value of a scope within which a message is to be output (presented) before a message specified by the above message code is output (presented) (in FIG. 32, expressed as “Spare scope for output of message (end)” and hereinafter, referred to as “End value of spare message output scope”), a message code for indicating a message to be output at each stage, (hereinafter referred to as “Spare message code”), a lower limit vale of a scope within which a counter plan is to be output (presented) (in FIG. 32, referred to as “Scope for output of counter plan (start)” and hereinafter referred to as “Start value of counter plan output scope”), an upper limit value of a scope within which a counter plan is to be output (presented) (in FIG. 32, referred to as “Scope for output of counter plan (end)” and hereinafter referred to as “End value of counter plan output scope”), a counter plan code for indicating a counter plan to be output, a lower limit value of a scope within which a message is to be output (presented) before a counter plan specified by the above counter plan code is output (presented) (in FIG. 32, expressed as “Spare scope for output of counter plan (start)” and hereinafter, referred to as “Start value of spare counter plan output scope”), an upper limit value of a scope within which a message is to be output (presented) before a counter plan specified by the above counter plan code is output (presented) (in FIG. 32, expressed as “Spare scope for output of counter plan (end)” and hereinafter, referred to as “End value of spare counter plan output scope”) and counter plan data for indicating a counter plan to be output at each stage are stored as data.

Among the above data, at least one of the group of data comprising the start value of message output scope, the end value of message output scope and the message code, and one of the group of data comprising the start value of counter plan output scope, the end value of counter plan output scope and the counter plan code are stored. On the other hand, a group of the start value of spare message output scope, the end value of spare message output scope and the spare message code, and one of the group of Start value of spare counter plan output scope, End value of spare counter plan output scope, and the counter plan code are stored as needed. Any group of data can be plurally stored. Thereby, various messages or counter plan can be presented to the engaged person in accordance with the extent of the deviation of the patient's status or the progress from the schedule.

Numerical values stored as the start value of message output scope and the like are set by taking the implementation data type code into consideration. When, for example, the type code indicates temperature (temperature measurement) or the like, the concrete value is obtained from the type code so that the value is set. When the type code indicates the pupillary light reflex or the like, it is difficult to express the patient's status strictly so that the numerical values evaluated in the plural stages such as five stages for example are set. When the type code indicates the insert of a balloon, medication or the like, it is important whether or not the such services are conducted so that the numerical values are evaluated in binary such as that “1” in case that the service is implemented and “0” in case that the service is not implemented.

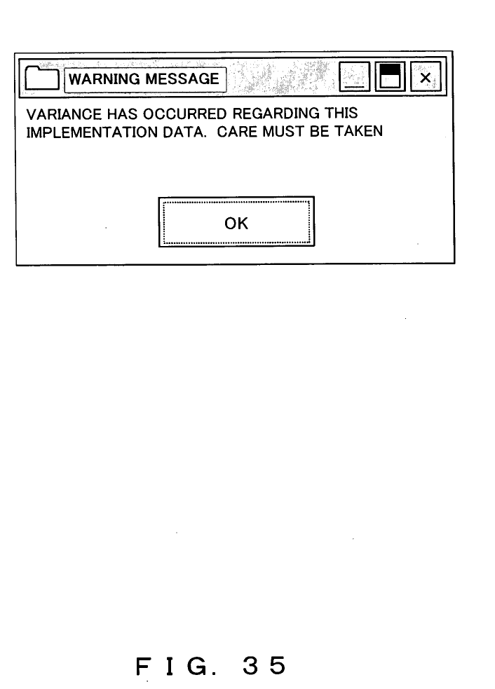

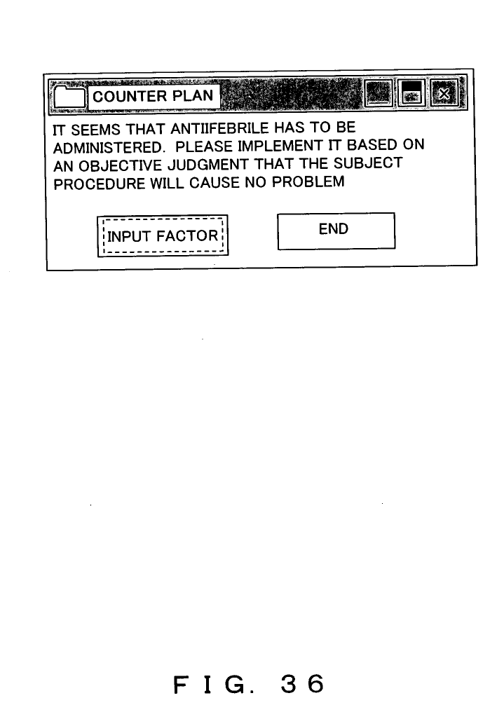

The message DB 3213 shown in FIG. 31 stores the data for outputting message specified by the above message code. Similarly, the counter plan DB 3214 stores data for outputting the counter plan specified by the counter plan code. By preparing these DBs 3213 and 3214, the message or the counter plan can be presented to the engaged person as shown in FIG. 35 or in FIG. 36.

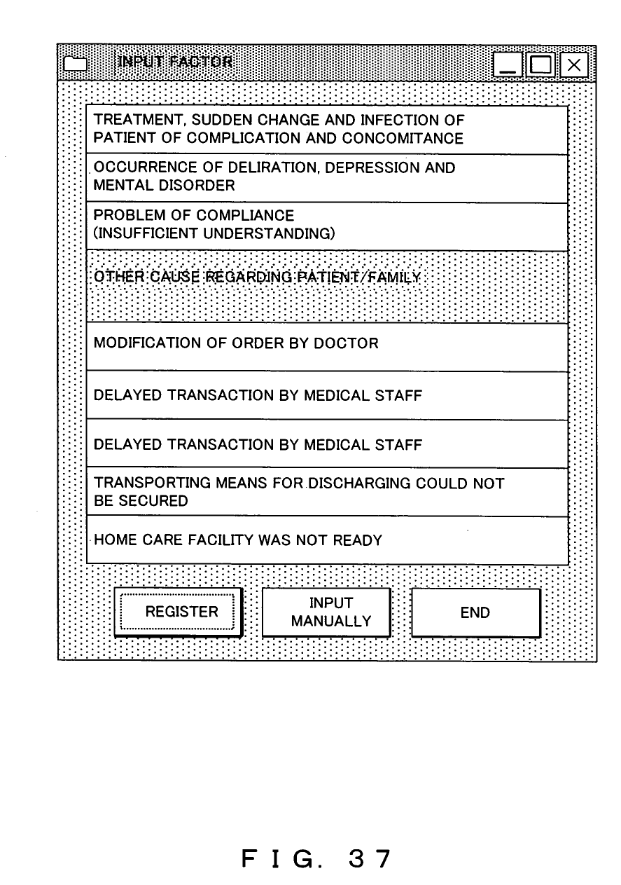

In the present embodiment, in case that a variance occurs, the content which is thought to have caused the variance is input as data by the engaged person in order to avoid the occurrence of the variance more surely, in other words, to implement more suitable medical services for a patient with higher possibilities. The input can be easily conducted by selecting the options prepared as the expected causes as shown in FIG. 37 and by making a comment when the corresponding cause is not included in the options. The difference cause master file 3216 is prepared for managing the options to be presented to the engaged person. The difference cause masterwork file 3215 is prepared for temporarily storing the cause input as the comment.

The managing system 302 realized sharing of information by supplying data stored in a DB managed in the storing unit 3203 or in a file in response to a request from the terminal device 304, or by registering data transmitted from the terminal device 304 in the corresponding DB or in a file. When the implementation data indicating the contents (medical services) implemented based on a clinical path is received as the above data from the terminal device 304, it is determined whether or not a variance has occurred based on the deviation of a patient's progress from the schedule so that the determination result is transmitted to the terminal device 304. Thereby, the presence/absence of a variance, the counter plan for the occurring variance and the like are presented to an engaged person.

The implementation data includes, for example, the type code, and the result data indicating the result of the implementation of the medical service indicated by the type code. When the type code indicates the temperature (temperature measurement), the result data is the measured temperature. The result data is immediately input after conducting medical services such as the examination, observation, medication and the like. It is for this reason that the presence/absence of variance is determined upon reception of the implementation data from the terminal device 304. Thereby, it is notified to the engaged person that a variance has occurred in an earlier stage so that when the medical service to be implemented exists, that medical service is notified as the counter plan in a timely manner.

When the occurrence of a variance is found in an earlier stage, the response for the variance can be made earlier, and more suitable medical services can be implemented for a patient in an earlier stage. Besides, the resources of the facility can be utilized more efficiently. When a counter plan is notified in a timely manner, the suitable medical services can be implemented rapidly at that moment regardless of the experience or the ability of the engaged person. Thereby, the quality of medical service can be improved more and the cost for the medical service can be reduced more.

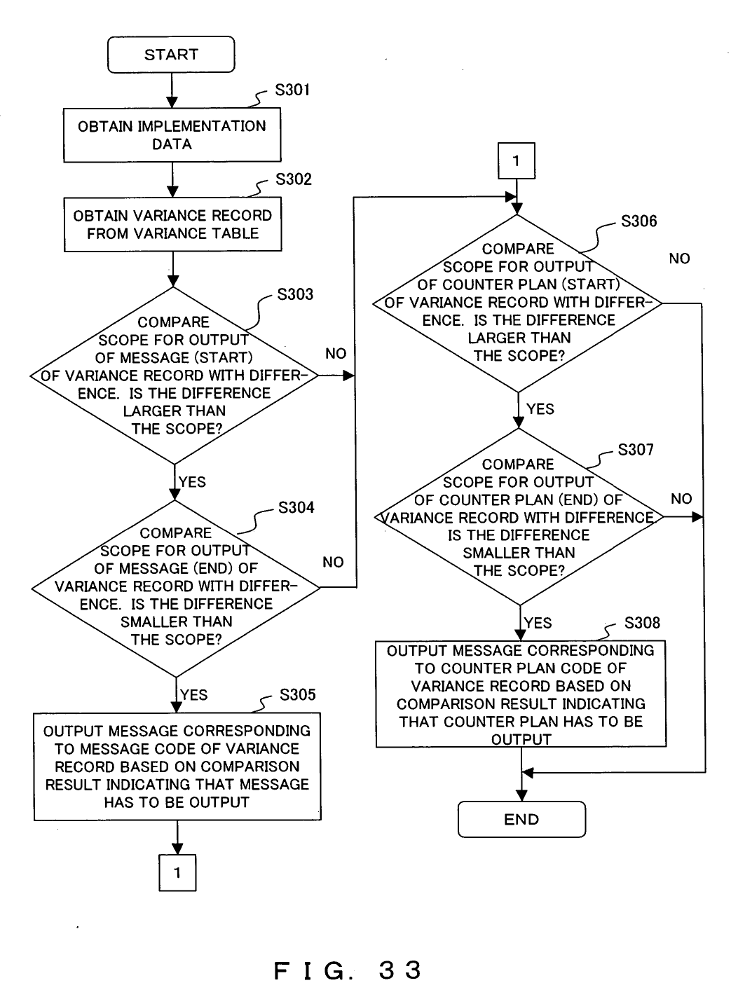

FIG. 33 is a flowchart of a variance determining process. The flowchart shows a basic sequence of processes executed for determining the presence/absence of the occurrence of variance by the managing system 302. The processes are executed when the implementation data is received from the terminal device 304. Next, a process executed by the managing system 302 for determining the presence/absence of the occurrence of the variance is explained in detail. From the terminal device 304, together with implementation data, a type code, personal data of a patient and a type code of an applied clinical path, of the implementation data are transmitted.

Firstly, in step S301, the implementation data received from the terminal device 304 is obtained. In the next step S302, the variance table to be referred to is extracted by searching the group of variance tables 3212 using, as keys, the type code, the personal data of a patient and the type code of a clinical path in the implementation data. Thereafter, the step S303 is executed.

In step S303, by comparing the start value of message output scope in the extracted variance table with the result data in the implementation data, it is determined whether or not the numerical value indicated by the result data is larger than the above start value. If the numerical value indicated by the result data is larger than the starting value, it is determined to be YES so that step S304 is executed, and if not, it is determined to be NO so that step S306 is executed.

In step S304, by comparing the end value of message output scope in the extracted variance table with the result data in the implementation data, it is determined whether or not the numerical value indicated by the result data is smaller than the above end value. If the numerical value indicated by the result data is smaller than the end value, i.e. if the numerical value is larger than the start value of message output scope and smaller than the end value of message output scope, it is determined to be YES so that in step S305, the message data is extracted from the message DB 3213 by using the message code in the variance table as a key. And after creating a warning message outputting window and transmitting the window to the terminal device 304, a warning message outputting window as shown in FIG. 35 in which the extracted message is arranged, a step S306 is executed. And if not, it is determined to be NO so that the next step S306 is executed.

In step S306, by comparing the start value of counter plan output scope in the extracted variance table with the result data in the implementation data, it is determined whether or not the numerical value indicated by the result data is larger than the above start value. If the numerical value indicated by the result data is larger than the start value, it is determined to be YES so that step S307 is executed. And if not, it is determined to be NO so that a series of processes are ended.

In step 307, by comparing the end value of counter plan output scope in the extracted variance table with the result data in the implementation data, it is determined whether or not the numerical value indicated by the result data is smaller than the above end value. If the numerical value indicated by the result data is smaller than the end value i.e. if the numerical value is larger than the start value of counter plan output scope and smaller than the end value of counter plan output scope, it is determined to be YES so that in step S308, the counter plan data is extracted from the counter plan DB 3214 by using the counter plan code in the variance table as a key. And a counter plan outputting window as shown in FIG. 36 in which the extracted counter plan is arranged is created and transmitted to the terminal device 304. Thereafter, a series of processes are ended. And if not, it is determined to be NO so that a series of processes are ended.

As above, the determination of presence/absence of occurrence of variance and the determination whether or not a message or counter plan is to be output (presented) are conducted by extracting and referring to the variance table to be referred to from the group of variance tables 3212. The occurrence of variance is notified to an engaged person as a user by transmitting, to the terminal device 304, the warning message outputting window as shown in FIG. 35 or the counter plan outputting window as shown in FIG. 36, and displaying them on the terminal device 304. The absence of the variance is notified to the engaged person by not transmitting such windows as above, however, the absence of the variance can be notified by transmitting a message or the like indicating it.

The data configuration of the above variance table is not limited to the one shown in FIG. 32. Therefore, as the contents of the determining processes to be actually conducted, various contents are conducted in accordance with each of the variance tables which are referred to. The determining process shown in FIG. 33 is for a case that the variance table is referred to one of the data groups comprising the start value of message output scope, the end value of message output scope and the message code, and one of the data groups comprising the start value of counter plan output scope, the end value of counter plan output scope and the counter plan code are respectively stored.

As shown in FIG. 36, on the counter plan outputting window, a “Input factor” button for inputting the factor (cause) of the occurrence of variance is arranged in addition to a “End” button for closing the window itself. Thereby, in the present embodiment, it is required to input the factor of a variance at the time when the occurrence of the variance is detected.

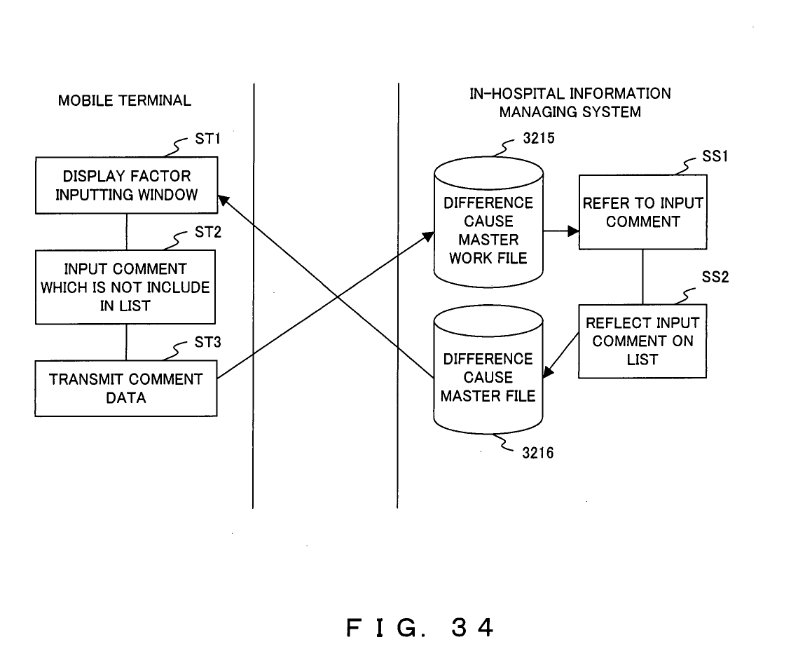

FIG. 34 is a flowchart for showing processes respectively executed by the terminal device 304 and the managing system 302 to realize the input of the factor. Referring to FIG. 34, the processes respectively executed by the terminal device 304 and the managing system 302 to realize the input of the factor are explained in detail.

Firstly, the process executed by the terminal device 304 is explained.

When the “Input factor” button on the counter plan outputting window as shown in FIG. 36 is clicked by an engaged person, the terminal device 304 notifies the fact of the button being clicked to the managing system 302. The managing system 302, upon receiving the notification, transmits to the terminal device 304 a factor inputting window on which the factors stored as options in the difference cause master file 3216 are arranged as shown in FIG. 37. Thereby, the terminal device 304 displays the window on such a displaying device included in the device 304 as a liquid crystal displaying device or the like in step ST1.

On the factor inputting window, a“Register” button, a “Input manually” button and a “End” button are arranged in addition to a list of options as shown in FIG. 37. Thereby, when a variance is thought to have occurred by a factor presented as one of the options, that factor can be registered by clicking the “Register” button after selecting the corresponding factor of the options. When the variance is thought to have occurred by a factor which is not presented as the options, the “Input manually” button is to be clicked.

When the above “Input manually” button is clicked, the terminal device 304 displays an inputting window (not shown) on which an area in which the cause is input, a “Register” button, a “End” button and “Go back” button are arranged. Thereby, the terminal device 304 executes the processes in step ST2 for conducting the input of the cause in accordance with the operations of the user until the user clicks the “Register” button after manually inputting the factor as comment data in the area.

When the “Register” button is clicked after inputting the factor, the terminal device executes step ST3 in order to transmit to the managing system 302 the factor input as the comment data. The managing system 302 stores thus received comment data from the terminal device 304 in the difference cause master work file 3215.

Next, the process executed by the managing system 302 is explained. Now, only the process related to the update of the difference cause master file 3216 is explained.

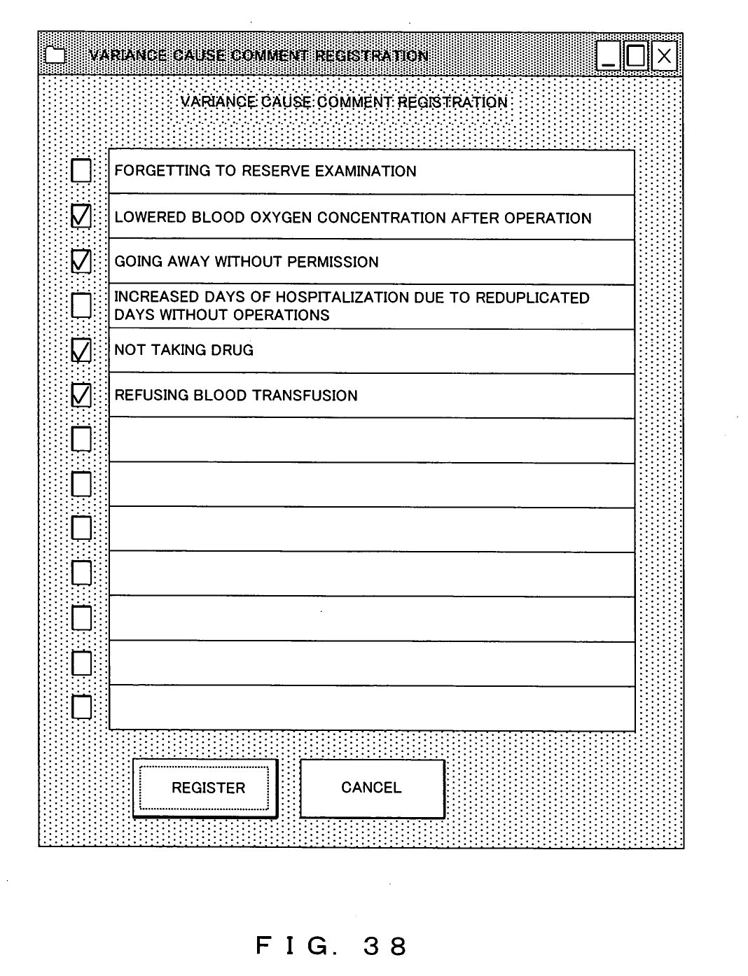

The managing system 302 creates a variance cause comment registration window on which a list of comments is arranged as shown in FIG. 38 and transmits the variance cause comment registration window to the terminal device 304 of the managing system 302 when the reference to the comment stored as data in the difference cause master work file 3215 is requested by the terminal device 304 used by a system administrator, for example (step SS1). The terminal device 304 displays the registration window on a displaying device included in or connected to the terminal device 304.

On the above registration window, a checkbox is arranged for each of comments by which the selection/non-selection is conducted, and a “Register” button and a “End” button are arranged. Thereby, the addition of comment as an option can be conducted by clicking the “Register” button after selecting or checking the checkbox corresponding to the comment to be added. When the “Register” button is thus clicked, the terminal device 304 transmits to the managing system 302 data specifying the selected comment so that the instruction of the addition of the option is notified.

The managing system 302, upon receiving the notification and data, identifies the selected comment based on the data and adds the comment as one option of the factors by extracting the data of the comment from the difference cause master work file 3215 and storing extracted data in the difference cause master file 3216 (step SS2). Thereby, after the above operations, the factor inputting window to which the comment is added is transmitted to the terminal device 304 used by the engaged person.

In fact, it is very difficult to prepare all of the items which are thought to be factors as the options in advance. The factor input as comment is a candidate for an option to be added. In the present embodiment, it is possible to add that comment as options by presenting the comment. Thereby, the options which is thought to be necessary can be easily prepared. Thereby, the input of the factor of variance can be easily conducted for the person to input the factor of variance because there are high possibilities that the factor to be input can be selected from the options.

Further, in the present embodiment, the determination of the presence/absence of occurrence of variance is conducted by the managing system 302, however, the above determination may be conducted by the terminal device 304. The determination by the terminal device 304 may be realized by causing the terminal device 304 to obtain the necessary data for the determination in advance, or by causing the terminal device 304 to obtain the necessary data whenever needed.

A plurality of kinds of medical services are sometimes conducted at once based on a clinical path. Therefore, the determination of the presence/absence of occurrence of variance may be conducted overall by referring to a plurality of variance tables as needed.

The determination of the presence/absence of occurrence of variance can be conducted relatively easily by a well experienced or able person engaged in medicine. Therefore, when the determination is conducted only by such a person engaged in medicine as above, the determination can be conducted by the person engaged in medicine for themselves by obtaining and presenting the implementation data and data of clinical path necessary for the determination.

A program for realizing the determination of the presence/absence of occurrence of variance in managing system 302 may be recorded and distributed on a storage medium such as a CD-ROM, a DVD, a magneto optical disk or the like. A part or whole of the program may be distributed via a transmission medium such as a communication network, a public network or the like. In such a case, by obtaining and downloading the program to a data processing device, a user can realize the nursing and medical assisting device to which the present invention is applied, by using the data processing device. Therefore, the storage medium may be one which the device distributing the program can access.

Accordingly, in the present invention, based on implementation data indicating the contents which were implemented as medical services for a patient and medical schedule data indicating a schedule of medical services to be implemented for the patient corresponding to the implementation data, it is determined whether or not the patient's progress has deviated from the schedule indicated by the medical schedule data, and the result of the determination is presented to an engaged person of medical service.

By presenting the above result of the determination, the fact that the actual patient's progress has deviated from the schedule (expectation) can be met surely and rapidly. Thereby, more suitable medical services can be implemented for a patient in an earlier stage so that the resources of facility can be utilized more efficiently. As a result, the quality of medical service can be improved more and the cost for the medical service can be reduced more.

In case that the counter plan is presented when it is determined that the actual patient's progress has deviated from the schedule (expectation), suitable medical services can be implemented rapidly regardless of the experience, ability or the like of an engaged person. In case that the supposed factor to be input upon the above is obtained, the supposed factor can be utilized for the medical services to be implemented in the future (including the avoidance of the deviation from the schedule).

1. A hospital information system for managing clinical path information constituted of a plurality of medical service information each indicating a schedule regarding a medical service for a patient, comprising:
an obtaining unit for obtaining the clinical path information;
a converting unit for converting the clinical path information into medical service notification information for notifying the medical service information to a medical department linked to the medical service in accordance with the medical service information; and
a transmitting unit for transmitting the medical service notification information to the medical department.

2. The hospital information system according to claim 1, wherein:
the converting unit extracts the medical service information from the clinical path information obtained by the obtaining unit in order to add information regarding the medical department to the extracted medical service information.

3. A hospital information system for managing clinical path information constituted of a plurality of medical service information each indicating a schedule regarding a medical service for a patient, comprising:
an obtaining unit for obtaining the clinical path information;
a determining unit for determining whether or not the schedule of the medical service indicated by the medical service information constituting the clinical path information can be implemented; and
a determination result modification notifying unit for making a notification to prompt a modification of the medical service information constituting the clinical path information, based on the determination result by the determining unit.

4. The hospital information system according to claim 3, wherein:
the determining unit compares a scheduled time and date of the medical service included in the medical service information constituting the clinical path information obtained by the obtaining unit, with a possible time and date for implementation or an impossible time and date for implementation of the medical service of the medical department linked to the medical service.

5. A hospital information system for managing clinical path information constituted of a plurality of medical service information each indicating a schedule regarding a medical service for a patient, comprising:
an obtaining unit for obtaining the clinical path information;
a storing unit for storing linkage information linking the plurality of the medical service information with one another;
a searching unit for, upon receiving modification order information regarding a prescribed medical service information among the clinical path information obtained by the obtaining unit, searching the linkage information for the medical service information linked to the prescribed medical service information; and
a search result modification notifying unit for making a notification to prompt a modification of the medical service information constituting the clinical path information, based on the search result by the searching unit.

6. The hospital information system according to claim 5, wherein:
the linkage information includes information indicating interval hours of the scheduled time and date indicated by the linked medical service information; and
the search result modification notifying unit makes the notification including a modification example of the medical service information created based on the interval hours corresponding to the medical service information searched for by the searching unit.

7. The hospital information system according to claim 6, further comprising:
a converting unit for obtaining the clinical path information in accordance with the medical service information modified after the notification by the search result modification notifying unit in order to convert the clinical path information into medical service notification information for notifying the medical service information to a medical department linked to the medical service in accordance with the medical service information; and
a transmitting unit for transmitting the medical service notification information to the medical department.

8. The hospital information system according to claim 7, wherein:
the converting unit extracts the medical service information from the clinical path information obtained by the obtaining unit in order to add information regarding the medical department to the extracted medical service information.

9. A hospital information system comprising:
a holding unit for holding clinical path standardized information which is progress information regarding a standardized medical service toward the target set for each of medical cases, being constituted of a plurality of medical service information each indicating a schedule regarding the medical service for a patient,
a clinical path information for each of patients obtaining unit for obtaining clinical path information for each of patients which is created based on the clinical path standardized information;
a creating and transmitting unit for creating and transmitting order information ordering that the medical service is to be implemented from the medical service information included in the clinical path information for each of the patients; and
an implementation result information obtaining unit for obtaining the implementation result information indicating the implementation result of the medical service implemented based on the order information.

10. The hospital information system according to claim 9, further comprising:
a standardized implementation comparing unit for comparing the clinical path standardized information with the implementation result information; and
a standardized implementation comparison notifying unit for notifying result of comparison by the standardized implementation comparing unit.

11. The hospital information system according to claim 9, further comprising:
a difference related information obtaining unit for obtaining difference related information which relates to difference between the clinical path standardized information and the implementation result information.

12. The hospital information system according to claim 11, wherein:
the difference related information is created by a mobile terminal.

13. The hospital information system according to claim 11, wherein:
the difference related information includes at least one of information regarding a factor causing the difference between the clinical path standardized information and the implementation result information, information regarding analysis of the factor and information regarding solution for the factor.

14. The hospital information system according to claim 9, further comprising:
an implementation result information among patients comparing unit for comparing among the implementation result information of a plurality of patients based on the same medical case; and
an implementation result information among patients comparison notifying unit for notifying result of comparison by the implementation result information among patients comparing unit.

15. The hospital information system according to claim 14, further comprising:
a reflecting unit for reflecting, on the clinical path standardized information, the comparison result by the implementation result information among patients comparing unit.

16. The hospital information system according to claim 15, wherein:
the implementation result information among patients comparing unit compares the clinical path standardized information and the implementation result information of each of patients.

17. A nursing and medical assisting device for assisting implementation of a medical service for a patient during treatment, comprising:
an implementation data obtaining unit for obtaining implementation data indicating content implemented as a medical service for the patient;
a medical schedule data obtaining unit for obtaining medical schedule data indicating a schedule of the medical service which is to be implemented for the patient;
a progress determining unit for determining whether or not, based on implementation data obtained by the implementation data obtaining unit and medical schedule data obtained by the medical schedule data obtaining unit corresponding to the obtained implementation data, a progress of the patient has deviated from the schedule indicated by the medical schedule data; and
a determination presenting unit for presenting determination result by the progress determining unit.

18. The nursing and medical assisting device according to claim 17, wherein:
the determination presenting unit, when the progress determining unit determines that there is a deviation of a progress of the patient from the schedule indicated by the medical schedule data, can present a counter plan for the deviation.

19. The nursing and medical assisting device according to claim 17, further comprising:
a factor obtaining unit for obtaining a supposed factor input by the determination, by the progress determining unit, that there is a deviation of a progress of the patient from the schedule indicated by the medical schedule data.

20. The nursing and medical assisting device according to claim 19, wherein:
when the supposed factor is selected from options or the supposed factor is input as comment based on the presented options of the supposed factor, the factor obtaining unit adds to the options the supposed factor input as obtained comment.

21. A nursing and medical assisting method for assisting implementation of a medical service for a patient during treatment, comprising:
an implementation data obtaining step in which implementation data indicating content implemented as a medical service for the patient is obtained;
a medical schedule data obtaining step in which medical schedule data indicating a schedule of the medical service which is to be implemented for the patient is obtained; and
a progress determining step in which it is determined whether or not, based on implementation data obtained in the implementation data obtaining step and medical schedule data obtained in the medical schedule data obtaining step corresponding to the obtained implementation data, progress of the patient has deviated from the schedule indicated by the medical schedule data.

22. A computer data signal realized on carrier waves for assisting implementation of medical service for a patient during treatment, causing a computer to execute;
an implementation data obtaining process of obtaining implementation data indicating content implemented as a medical service for the patient;
a medical schedule data obtaining process of obtaining medical schedule data indicating a schedule of the medical service which is to be implemented for the patient;
a progress determining process of determining whether or not, based on implementation data obtained in the implementation data obtaining process and medical schedule data obtained in the medical schedule data obtaining process corresponding to the obtained implementation data, a progress of the patient has deviated from the schedule indicated by the medical schedule data; and
a determination presenting process of presenting determination result by the progress determining process.

23. A hospital information system for managing clinical path information constituted of a plurality of medical service information each indicating a schedule regarding a medical service for a patient, comprising:
obtaining means for obtaining the clinical path information;
converting means for converting the clinical path information into medical service notification information for notifying the medical service information to a medical department linked to the medical service in accordance with the medical service information; and
transmitting means for transmitting the medical service notification information to the medical department.

24. A hospital information system for managing clinical path information constituted of a plurality of medical service information each indicating a schedule regarding a medical service for a patient, comprising:
obtaining means for obtaining the clinical path information;
determining means for determining whether or not the schedule of the medical service indicated by the medical service information constituting the clinical path information can be implemented; and
determination result modification notifying means for making a notification to prompt a modification of the medical service information constituting the clinical path information, based on the determination result by the determining means.

25. A hospital information system for managing clinical path information constituted of a plurality of medical service information each indicating a schedule regarding a medical service for a patient, comprising:
obtaining means for obtaining the clinical path information;
storing means for storing linkage information linking the plurality of the medical service information with one another;
searching means for, upon receiving modification order information regarding a prescribed medical service information among the clinical path information obtained by the obtaining means, searching the linkage information for the medical service information linked to the prescribed medical service information; and
search result modification notifying means for making a notification to prompt a modification of the medical service information constituting the clinical path information, based on the search result by the searching means.

26. A hospital information system comprising:
holding means for holding clinical path standardized information which is progress information regarding a standardized medical service toward the target set for each of medical cases, being constituted of a plurality of medical service information each indicating a schedule regarding the medical service for a patient,
clinical path information for each of patients obtaining means for obtaining clinical path information for each of patients which is created based on the clinical path standardized information;
creating and transmitting means for creating and transmitting order information ordering that the medical service is to be implemented from the medical service information included in the clinical path information for each of patients; and
implementation result information obtaining means for obtaining the implementation result information indicating the implementation result of the medical service implemented based on the order information.

27. A nursing and medical assisting device for assisting implementation of a medical service for a patient during treatment, comprising:
implementation data obtaining means for obtaining implementation data indicating content implemented as a medical service for the patient;
medical schedule data obtaining means for obtaining medical schedule data indicating a schedule of the medical service which is to be implemented for the patient;
progress determining means for determining whether or not, based on implementation data obtained by the implementation data obtaining means and medical schedule data obtained by the medical schedule data obtaining means corresponding to the obtained implementation data, a progress of the patient has deviated from the schedule indicated by the medical schedule data; and
determination presenting means for presenting determination result by the progress determining means.
